(19) United States
(12) Patent Application Publication
(10) Pub. No.: US 2025/0134192 A1
(43) Pub. Date: May 1, 2025

(54) GLOVE WITH TEXTURED PALM REGION AND DIFFERENTLY TEXTURED DIGIT REGIONS

(71) Applicant: Summit Glove Inc., Minerva, OH (US)

(72) Inventor: James L. HULL, Malvern, OH (US)

(73) Assignee: Summit Glove Inc., Minerva, OH (US)

(21) Appl. No.: 18/494,860

(22) Filed: Oct. 26, 2023

(51) Int. Cl. A41D 19/00; B29D 99/00; B29K 33/18

(52) U.S. Cl. CPC A41D 19/0096; A41D 19/0062; B29D 99/0067; A41D 2400/80; A41D 2500/00; A41D 2600/20; B29K 2033/18

(57) ABSTRACT

A glove and method of manufacture thereof. The glove includes a wrist region, a palm region extending outwardly from the wrist region, and a plurality of digit regions extending outwardly from the palm region. A front surface of the palm region and a front surface of the plurality of digit regions will be contacted by an object when the object is gripped in the hand of a user wearing the glove. A first texture is provided on the front surface the palm region and a second texture is provided on the front surface of the plurality of digit regions. The first texture and second texture are different from one another. In one embodiment, a sand pattern is micro-etched into the palm region and a raised diamond pattern is molded into the plurality of digit regions. Gripping zones are molded into the rear surface of the digit regions.

### TECHNICAL FIELD

This disclosure is directed to gloves. More particularly, the present disclosure relates to nitrile gloves. Specifically, the disclosure is directed to gloves which has a palm region with a front surface having a first texture thereon and digit regions each having a front surface with a second texture thereon, wherein the first texture and the second texture are of different configurations from one another.

### BACKGROUND ART

Gloves are typically worn in a variety of different industrial applications. The gloves help to protect a worker's hands from various materials with which the worker may have to come into contact or physically manipulate. The gloves may also help protect the worker's hands from cuts and abrasions.

One industry in which gloves are worn is that of meat packing. Meat packers regularly come into contact with a variety of bodily fluids which can expose them to pathogens and/or to corrosive chemicals like ammonia which is used as a refrigerant. The fluids can be quite corrosive to the person's skin and gloves help to shield the person's hands from these fluids.

Meat packers frequently work with sharp knives and other dangerous cutting equipment and may be required to work at a fast processing speed. Under these conditions, accidents with knives and dangerous equipment may be exacerbated by the product they are handling being wet and slippery. Gloves are once again necessary to try and protect peoples' hands as they perform their duties.

### SUMMARY OF THE INVENTION

The present disclosure is directed to a glove which is useful in industries like meat packing. In particular, the disclosed glove is configured to provide a worker with improved gripping action when handling products, particularly wet and slippery products. The glove also offers improved wicking of moisture away from the gripping surfaces of the glove. The gloves configuration also offers improved strength and resistance to tearing during use. Finally, the glove is fabricated to be resistant to many corrosive substances and includes a tear indicator which rapidly enables a worker to determine their glove has been compromised in some fashion.

The glove in accordance with the present disclosure is configured for use in industries such as meat packing. The glove is able to be worn on its own in any environment, or is able to be worn under another glove in a cold environment or any other environment, or is able to be worn over another glove in a cold environment or any other environment.

In one aspect, an exemplary embodiment of the present disclosure may provide a glove comprising a wrist region; a palm region extending outwardly from the wrist region; a plurality of digit regions extending outwardly from the palm region; a first texture provided on the palm region; and a second texture provided on one or more digit regions of the plurality of digit regions, wherein the second texture is different to the first texture.

In one embodiment, the first texture may be micro-etched into the front surface of the palm region. In one embodiment, the first texture is in a form of a sand pattern. In one embodiment, the second texture is a diamond pattern produced on the front surface of the one or more digit regions. In one embodiment, the diamond pattern is a raised diamond pattern. In one embodiment, a texture-free zone located between the first texture provided on the palm region and the second texture provided on the one or more digit regions. In one embodiment, the texture-free zone is on the palm region between an upper boundary of the first texture and a plurality of finger crotches extending between adjacent digit regions of the plurality of digit regions. In one embodiment, the first texture is provided on a front surface of the palm region and the second texture is provided on a front surface of the one or more digit regions, and wherein a rest of the glove is smooth and free of texture. In one embodiment, the palm region has a front surface which is adapted to contact an object held in a hand of a user while wearing the glove; and wherein the first texture is provided on at least a portion of the front surface of the palm region.

In one embodiment, the first texture on the front surface of the palm region extends between an upper boundary on the palm region to a lower boundary on the palm region, wherein the upper boundary is spaced a distance downwardly away from an imaginary line passing through a plurality of digit crotches extending between adjacent digit regions. In one embodiment, the upper boundary is oriented generally orthogonally to a longitudinal axis of the wrist region and extends from proximate a first side of the front surface of the palm region to proximate a second side of the front surface of the palm region. In one embodiment, a zone extends between the imaginary line and the upper boundary, and wherein the zone is free of texture and is smooth. In one embodiment, the lower boundary is located generally where the palm region of the glove transitions to the wrist region of the glove. In one embodiment, the plurality of digit regions includes a thumb region, and wherein the lower boundary originates at a base of the thumb region where the thumb region transitions into the wrist region, and wherein the lower boundary is oriented transverse to a longitudinal axis of the wrist region. In one embodiment, the front surface of the palm has a first side and a second side, wherein the upper boundary extends between the first side and the second side, and wherein the lower boundary originates proximate the second side and terminates before reaching the first side. In one embodiment, an arcuate boundary extends between the termination of the lower boundary and the first side, and wherein first texture is provided on the palm region between the upper boundary, the lower boundary, the first side, and the arcuate boundary.

In one embodiment, the plurality of digit regions includes an index finger region, a middle finger region, a ring finger region, and a little finger region, and wherein the palm region has a maximum width below extending from proximate the index finger region to proximate the little finger region, and wherein the front surface of the palm region proximate the upper boundary which includes the first texture extends across substantially the maximum width of the palm region. In one embodiment, the front surface of the palm region proximate the lower boundary and provided with first texture extends across less than the maximum width of the palm region. In one embodiment, the front surface of the palm region which includes first texture tapers in width between the first side of the palm region and the arcuate boundary to a minimum width along the lower boundary. In one embodiment, each of the digit regions has a front surface which is adapted to contact an object held in a hand of the user while wearing the glove; and wherein the second texture is provided on at least a portion of the front surface of one or more of the digit regions. In one embodiment, the digit regions comprise a thumb region, an index finger region, a middle finger region, a ring finger region, and a little finger region; and wherein a digit crotch extends between adjacent digit regions, wherein the second texture provided on the front surface of a respective digit region extends from a tip of the respective digit region to proximate the digit crotch. In one embodiment, a plurality of gripping zones are provided in a rear surface of at least one of the plurality of digit regions.

In another aspect, an exemplary embodiment of the present disclosure may provide a method of forming a glove comprising providing a former in a shape of a human hand; dipping the former into liquid nitrile; molding the glove on the former; creating a first texture on a front surface of a palm region of the glove; and creating a second texture on a front surface of one or more of a plurality of digit regions extending outwardly from the palm region, wherein the second texture is different to the first texture.

In one embodiment, creating the first texture comprises micro-etching the first texture into the front surface of the palm region. In one embodiment, creating the second texture comprises molding a raised diamond pattern or embossing a raised diamond pattern into the front surface of the one or more of the plurality of digit regions. In one embodiment, a plurality of gripping zones are molded into a rear surface of at least one of the plurality of digit regions, where the rear surface is opposed to the front surface of the at least one of the plurality of digit regions.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a perspective view of a first example of a first embodiment of a hand-specific glove in accordance with the present disclosure, wherein the glove is configured to be worn on a left hand of a user;

FIG. 2 is a front elevation view of the glove of FIG. 1;

FIG. 2A is a front elevation view of the glove of FIG. 2 identifying the boundaries of the palm region which are provided with a first texture;

FIG. 3 is a rear elevation view of the glove of FIG. 2;

FIG. 4A is a cross-sectional view of the middle finger region of the glove taken along and looking in the direction of 4A-4A of FIG. 3, wherein the middle finger region is shown in use with a person's middle finger received therein, and with the middle finger region in a straight condition;

FIG. 4B is a cross-sectional view of the middle finger region similar to FIG. 4A but showing the middle finger region in a bent condition;

FIG. 5A is a first operational view showing the glove of FIG. 1 positioned for donning on a person's hand;

FIG. 5B is a second operational view showing the glove of FIG. 1 positioned for donning on a person's hand, where the person's hand is already covered by another glove having different characteristics to the glove in accordance with the present disclosure;

FIG. 6A is a perspective view of a second example of the first embodiment of the glove shown in FIG. 1;

FIG. 6B is a perspective view of a third example of the first embodiment of the glove shown in FIG. 1;

FIG. 6C is a perspective view of a fourth example of the first embodiment of the glove shown in FIG. 1;

FIG. 6D is a perspective view of a fifth example of the first embodiment of the glove shown in FIG. 1;

FIG. 7 is a perspective view of a first example of a second embodiment of a hand-specific glove in accordance with the present disclosure, wherein the glove is configured to be worn on a left hand of a user;

FIG. 8 is a front elevation view of the glove of FIG. 7;

FIG. 9 is a rear elevation view of the glove of FIG. 7;

FIG. 10A is a perspective view of a second example of the second embodiment of the glove shown in FIG. 7;

FIG. 10B is a perspective view of a third example of the second embodiment of the glove shown in FIG. 7;

FIG. 10C is a perspective view of a fourth example of the second embodiment of the glove shown in FIG. 7;

FIG. 10D is a perspective view of a fifth example of the second embodiment of the glove shown in FIG. 7;

FIG. 11 is a perspective view of a first example of a third embodiment of a hand-specific glove in accordance with the present disclosure, wherein the glove is configured to be worn on a left hand of a user;

FIG. 12 is a front elevation view of the glove of FIG. 11;

FIG. 13 is a rear elevation view of the glove of FIG. 11;

FIG. 14A is a perspective view of a second example of the third embodiment of the glove shown in FIG. 11;

FIG. 14B is a perspective view of a third example of the third embodiment of the glove shown in FIG. 11;

FIG. 14C is a perspective view of a fourth example of the third embodiment of the glove shown in FIG. 11;

FIG. 14D is a perspective view of a fifth example of the fifth embodiment of the glove shown in FIG. 11;

FIG. 15 is a perspective view of a first example of a fourth embodiment of a hand-specific glove in accordance with the present disclosure, wherein the glove is configured to be worn on a left hand of a user;

FIG. 16 is a front elevation view of the glove of FIG. 15;

FIG. 17 is a rear elevation view of the glove of FIG. 15;

FIG. 18A is a perspective view of a second example of the fourth embodiment of the glove shown in FIG. 15;

FIG. 18B is a perspective view of a third example of the fourth embodiment of the glove shown in FIG. 15;

FIG. 18C is a perspective view of a fourth example of the fourth embodiment of the glove shown in FIG. 15;

FIG. 18D is a perspective view of a fifth example of the fourth embodiment of the glove shown in FIG. 15;

FIG. 19 is a perspective view of a first example of a fifth embodiment of a glove in accordance with the present disclosure, wherein the glove is an ambidextrous oriented so as to be able to be worn on a left hand of a user;

FIG. 20 is a front elevation view of the glove of FIG. 19;

FIG. 21 is a rear elevation view of the glove of FIG. 19;

FIG. 22A is a front elevation view of a second example of the fifth embodiment of the glove shown in FIG. 19;

FIG. 22B is a front elevation view of a third example of the fifth embodiment of the glove shown in FIG. 19;

FIG. 22C is a front elevation view of a fourth example of the fifth embodiment of the glove shown in FIG. 19;

FIG. 22D is a front elevation view of a fifth example of the fifth embodiment of the glove shown in FIG. 19;

FIG. 23 is a perspective view of a first example of a sixth embodiment of a glove in accordance with the present disclosure, wherein the glove is an ambidextrous oriented so as to be able to be worn on a left hand of a user;

FIG. 24 is a front elevation view of the glove of FIG. 23;

FIG. 25 is a rear elevation view of the glove of FIG. 23;

FIG. 26A is a front elevation view of a second example of the sixth embodiment of the glove shown in FIG. 23;

FIG. 26B is a front elevation view of a third example of the sixth embodiment of the glove shown in FIG. 23;

FIG. 26C is a front elevation view of a fourth example of the sixth embodiment of the glove shown in FIG. 23; and

FIG. 26D is a front elevation view of a fifth example of the sixth embodiment of the glove shown in FIG. 23.

Similar numbers refer to similar parts throughout the drawings.

### DETAILED DESCRIPTION

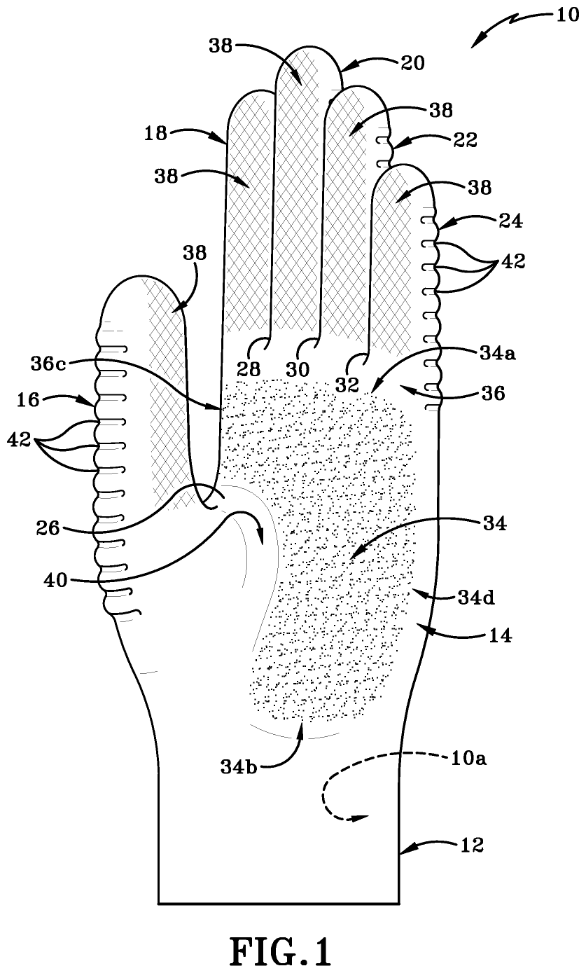

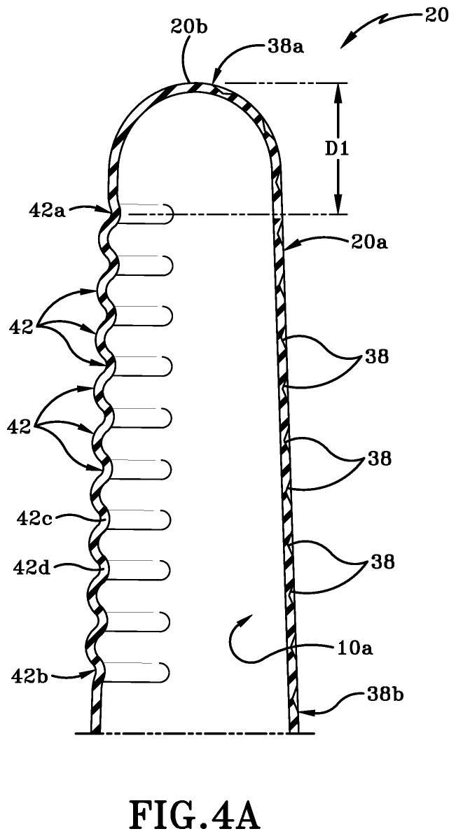

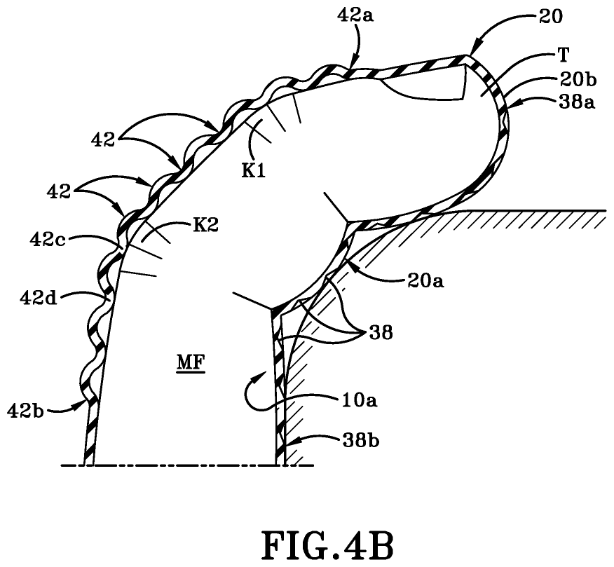

Referring now to FIGS. 1-4B there is shown a first example of a first embodiment of a glove in accordance with an aspect of the present disclosure, generally indicated at 10. Glove 10 comprises a wrist region 12, a palm region 14, a thumb region 16, an index finger region 18, a middle finger region 20, a ring finger region 22, and a little finger region 24. Glove 10 defines an interior cavity 10a which is configured to receive a hand of a person therein. Thumb region 16, index finger region 18, middle finger region 20, ring finger region 22, and little finger region 24 comprise digit regions which extend outwardly from palm region. The digit regions are configured to receive an associated one of a thumb, an index finger, a middle finger, a ring finger, and a little finger of the person's hand, respectively. FIG. 4B, for example, shows a person's middle finger “MF” received within a portion of the interior cavity 10a defined by middle finger region 20.

Glove 10 as illustrated in FIGS. 1-4A is a hand-specific glove which is configured to be worn on a left hand of a person. It will be understood that a glove configured to be worn on a right hand of the person will be a mirror image of the glove 10 shown in FIGS. 1 through 3. In the hand-specific glove 10, each of the index finger region 18, middle finger region 20, ring finger region 22, and little finger region 24 are aligned along a common plane while the thumb region 16 is not aligned along the common plane “P” but is instead arranged in another plane.

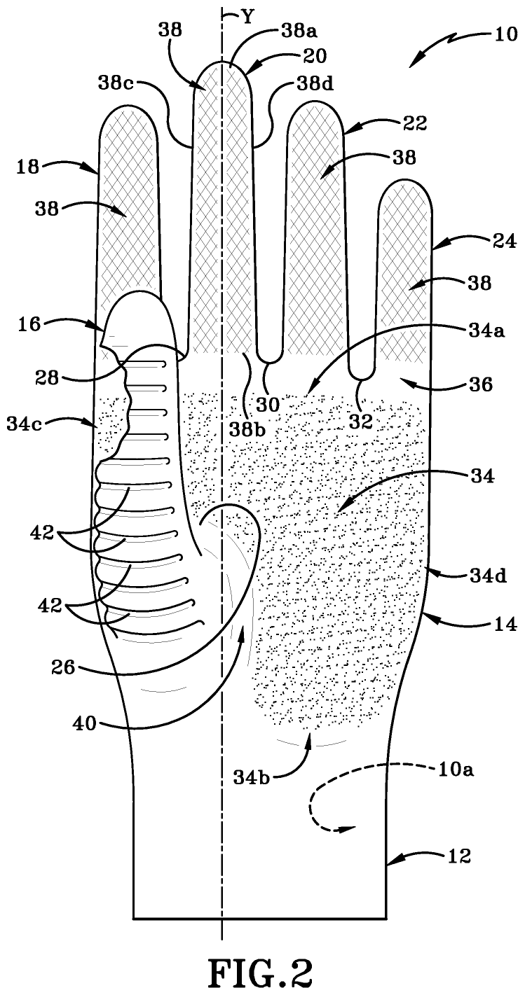

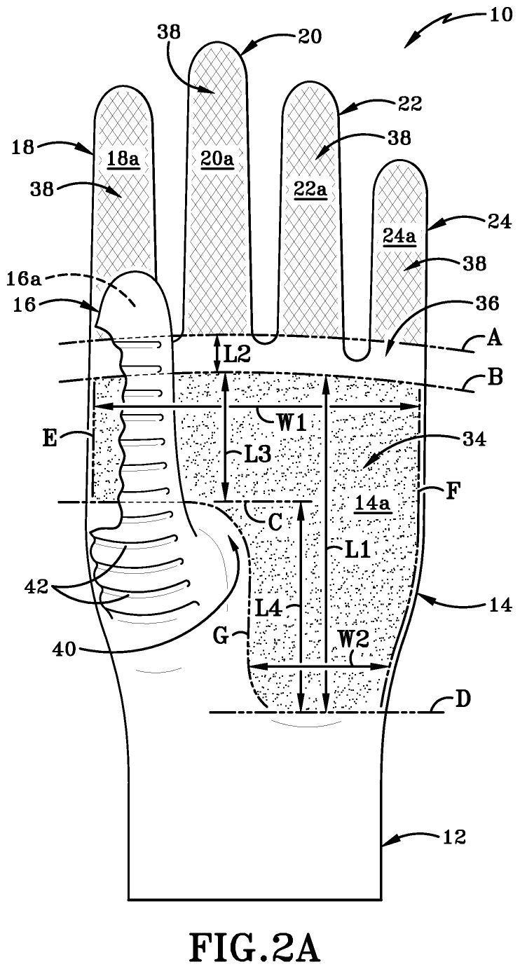

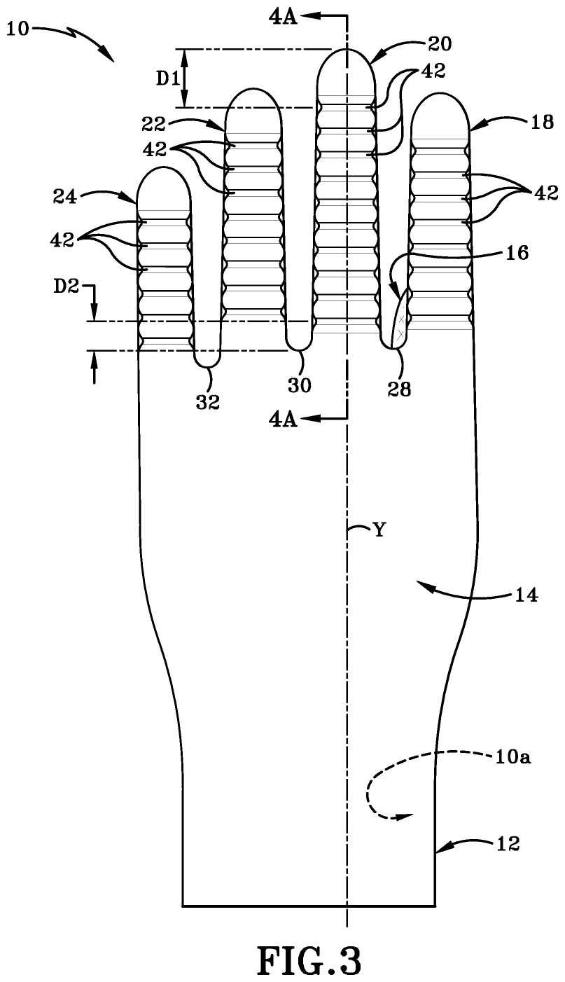

When glove 10 is worn on the left hand as illustrated in FIG. 2, the surface of the glove facing the viewer of the figure may be considered to be the “front” of the glove 10. The front of glove 10 is that part of glove 10 which will contact an object held in the left hand of the person wearing glove 10. Because FIG. 2 shows a “front” view of glove 10, the surfaces of the wrist region 12, palm region 14, and digit regions 16-24 facing the viewer of FIG. 2 are considered to be the “front” surfaces of the wrist region 12, palm region 14, and digit regions 16, 18, 20, 22, and 24. In view of this, FIG. 3 then illustrates a “back” of glove 10. Consequently, the surfaces of the wrist region 12, palm region 14, and digit regions facing the viewer of FIG. 3 are considered to be the “back” surfaces of the wrist region 12, palm region 14, and digit regions 16, 18, 20, 22, and 24. It will be understood that the side surfaces of the glove looking in a direction towards thumb region 16 and ultimately towards little finger region 24 may be considered to be the left side surfaces of the wrist region 12, palm region 14, and digit regions 16-24. Similarly, it will be understood that the side surface of the glove 10 looking in a direction towards little finger region 24 and ultimately towards thumb region 16 may be considered to be the right side surface of the wrist region 12, palm region 14, and digit regions 16-24.

It should be noted that the terms “front”, “back”, “left”, and “right” are used herein for ease of description only and particularly describe the specific orientation of the glove 10 illustrated in FIGS. 1 through 4B. Since glove 10 may be positioned in a variety of different orientations and positions during use, the terms “front”, “back”, “left”, and “right” used herein should not be narrowly construed and limiting.

FIGS. 1, 2, and 2A show that a crotch is formed between each pair of adjacent digits on glove 10. A first crotch 26 extends between thumb region 16 and index finger region 18. A second crotch 28 extends between index finger region 18 and middle finger region 20. A third crotch 30 extends between middle finger region 20 and ring finger region 22. A fourth crotch 32 extends between ring finger region 22 and little finger region 24. The first crotch 26, second crotch 28, third crotch 30, and fourth crotch 32 will be referred to hereafter as digit crotches 26-32.

In accordance with an aspect of the present disclosure, the front surfaces of palm region 14 and digit regions 16-24 is textured to improve the ability of a person to grip an object held in their hand. The front surface or gripping area of palm region 14 is indicated in FIG. 2 is indicated by the reference number 14a. The front surface or gripping area of thumb region 16 is indicated by reference number 16a. Similarly, the front surface or gripping area of the remaining digit regions are indicated by reference numbers 18a, 20a, 22a, and 24a.

In accordance with an aspect of the present disclosure, the front surface 14a of palm region 14 is provided with a first texture, generally indicated at 34. Referring to FIG. 2A there is shown an imaginary line “A” which runs across an uppermost part of palm region 14 and generally through finger crotches 28, 30, and 32. A line “B” delineates an upper boundary line of the portion of palm region 14 which includes first texture 34. The upper boundary of the first texture is also identified by the reference character 34a in FIG. 2. The line “C” shown in FIG. 2A delineates a bottom of a widest section of the first texture 34 on palm region 14, as will be discussed below. Line “C” originates generally in thumb crotch 26 and is basically parallel to line “B”. Line “D” in FIG. 2A is a lower boundary of the area of palm region 14 provided with first texture 34. The lower boundary of the area of palm region 14 including first texture 34 is also identified by the reference character 34b in FIG. 2. The lower boundary “D”, 34b will generally correspond to the position of the bottom of the palm of a person's hand (where the palm transitions into the wrist) when the glove is worn.

Referring still to FIG. 2A, the line “E” delineates a left boundary of the area of the palm region 14 provided with first texture 34. It should be noted that the left boundary “E” (also identified by the reference character 34c in FIG. 2), is on the front surface 14a of the palm region 14 and not on the left side surface of glove 10. Line “F” delineates a right boundary of the area of palm region 14 which is provided with first texture 34. The right boundary “F” (also identified by the reference character 34d in FIG. 2), is on the front surface 14a of palm region 14 and not on the right side surface of glove 10. Line “G” on FIG. 2A is an arcuate boundary of the area of palm region 14 which is provided with first texture 34. The arcuate boundary “G” is also identified by the reference character 34e in FIG. 2. It should be noted that the arcuate boundary “G”, 34e, corresponds generally to where a “meaty” part of the base of a person's thumb will join the rest of the person's palm when glove 10 is worn.

Referring still to FIG. 2A, the total length of palm region 14 from line “A” to the lower boundary “D”, 34b is indicated by reference character “L1”. The distance between line “A” to the upper boundary “B”, 34a is indicated by the reference character “L2”. The distance between upper boundary “B”, 34a to line “C” is indicated by the reference character “L3”. The distance between line “C” and lower boundary “D”, 34b is indicated by the reference character “L4”. As will be evident from FIG. 2, the area of first texture 34 on palm region 14 extends from the upper boundary “B”, 34a to the lower boundary “D”, 34b. The total length of the area of first texture 34 is therefor of a length “L3” plus “L4”. The total length “L1” of the palm region 14 is longer than the area provided with first texture 34 with is of the length “L3” plus “L4”. As is evident from FIG. 2, a zone is defined between line “A” and upper boundary line “B”, 34a. This zone is identified by the reference number 36. In accordance with an aspect of the present disclosure, zone 36 is free of any texturing, i.e., zone 36 is smooth.

Referring still to FIG. 2A, the maximum width of the area of palm region 14 including first texture 34 extends from left boundary “E”, 34c to right boundary “F”, 34d. The maximum width is identified by the reference character “W1”. The area of maximum width “W1” extends between upper boundary “B”, 34a and boundary line “C”. The minimum width of the area of palm region 14 which includes first texture 34 extends along lower boundary line “D”, 34b and from arcuate boundary “G” to right boundary “F”. The minimum width is indicated by reference character “W2”. Between boundary line “C” and lower boundary line “D”, 34b, the width of the area of palm region 14 which includes first texture 34 gradually tapers from maximum width “W1” to minimum width “W2”.

In accordance with an aspect of the present disclosure, the first texture 34 provided on palm region 14 comprises texturing produced through micro-etching an exterior surface of glove 10. The micro-etching is accomplished through any suitable process known in the art. Micro-etching of palm region 14 to produce first texture 34 creates a sand pattern texture on front surface 14a of palm region 14. The texturing in this manner has been found to increase the grip-ability of the glove material forming palm region 14. The type of first texturing 34 also marginally thickens the glove material in the textured area of palm region 14. This aids in strengthening of the glove material, thereby helping glove 10 to maintain its integrity on the person's hand during use. First texture 34 also tends to help ensure the palm region 14 resists damage and remains intact during use.

In accordance with yet another aspect of the present disclosure, the front surface 16a, 18a, 20a, 22a, 24a of each of the thumb region 16, index finger region 18, middle finger region 20, ring finger region 22, and little finger region 24, respectively is textured with a second texture generally indicated at 38. The front surfaces 16a, 18a, 20a, 22a, and 24a of thumb region 16, index finger region 18, middle finger region 20, ring finger region 22, and little finger region 24, respectively, is that surface which could contact an object gripped in a person's hand while wearing glove 10.

As indicated above, the first texture 34 is provided on the front surface 14a of the palm region 14 and the second texture 38 is provided on a front surface 16a, 18a, 20a, 22a, 24a of the digit regions, but the rest of the glove 10 is smooth and free of texture. In other words, the rear surfaces of the palm region 14 and the digit regions 16-24 shown at least in FIG. 3, and the left side surface and right side surfaces of the palm region 14 and digit regions 16-24 are smooth and free of texture.

In accordance with an aspect of the present disclosure, second texture 38 is of a different configuration from first texture 34. As discussed earlier herein, palm region 14 is micro-etched to product first texture 34. By contrast, second texture 38 comprises a raised diamond pattern formed in the various front surfaces 16a, 18a, 20a, 22a, and 24a. The raised diamond pattern may be produced in any suitable manner. For example, the raised diamond pattern of the second texture 38 may be produced by molding the glove material forming the various digit regions such that the glove material assumes the raised diamond configuration. In other embodiments, the raised diamond pattern may be embossed otherwise applied onto the exterior surface of the front surfaces 16a, 18a, 20a, 22a, and 24a of thumb region 16, index finger region 18, middle finger region 20, ring finger region 22, and little finger region 24.

Regardless how the raised diamond pattern is provided in the front surfaces 16a, 18a, 20a, 22a, 24a, in each of these digit regions, the second texture 38 originates in an upper boundary 38a proximate a tip of the associated digit region. The second texture 38 extends downwardly to a lower boundary 38b proximate the finger crotches 28, 30, 32. Furthermore, second texture 38 extends from a left boundary 38c to a right boundary 38c on the front surface of the associated digit region. It should be noted that the second texture 38 does not extend onto the left side surface and the right side surface of the associated digit region. In other words, the second texture 38 extends along substantially the entire length and width of each digit region. Substantially the entire front surface of each digit region which could contact an object being gripped in the user's hand is provided with second texture 38.

In accordance with an aspect of the present disclosure and as discussed earlier herein, a texture-free zone 36 extends between the first texture 34 on palm region 14 and the second texture 38 on the front surface 18a, 20a, 22a, 24a of digit regions 18-24. Zone 36 is free of texture and is smooth. The texture-free zone 36 extends from proximate a left side of the palm region 14 to a right side of the palm region 14.

A second arcuately-shaped texture-free zone 40 extends between the arcuate boundary line “G” on palm region 14 and the second texture 38 on thumb region 16. The texture-free zone 40 is best seen in FIG. 1. Texture-free zones 36 and 40 are substantially continuous with one another. The texture-free zones 36, 40 make it easier for a user wearing glove 10 to flex and move their fingers and thumb during performance of a task while wearing glove 10. Without the texture free zones 36, 40, the first texture 34 and second texture 38 might interfere with one another and hinder movement of the person's fingers and thumb.

Referring to FIGS. 1-4B, in accordance with yet another aspect of the present disclosure, a plurality of gripping zones 42 are formed in the rear surface of each digit region 16, 18, 20, 22, and 24. The rear surface is opposed to the front surfaces 16a, 18a, 20a, 22a, and 24a of the respective digit regions and will not be contacted by an object gripped within the person's hand when the glove 10 is worn.

FIG. 4A shows middle finger region 20 by way of example only but it will be understood that the following description applies to all other digit regions. Each gripping zone 42 on middle finger region 20 is arranged generally orthogonally to a longitudinal axis “Y” (FIG. 3) of middle finger region 20. The plurality of gripping zones 42 comprise a series of undulations, i.e., alternating peaks and valleys, formed in the glove material. The peaks of the undulations are arranged at substantially regular intervals from one another. The uppermost undulation 42a on middle finger region 20 is located a first distance “D1” away from a tip 20b of the middle finger region 20 (see FIG. 3 and FIG. 4A). The lowermost undulation 42b is located a distance “D2” from the finger crotches 28, 30 adjacent a base of middle finger region 20. As such, when glove 10 is worn, the plurality of gripping zones 42 will originate in the uppermost undulation 42a located between the tip “T” (FIG. 4B) of the person's middle finger “MF” and their first knuckle “K1”. The undulations 42 will extend over the person's first knuckle “K1” (FIG. 4B) of the middle finger “MF”, over their second knuckle “K2”, and will terminate in the lowermost undulation 42b. As shown in FIG. 3, the lowermost undulation 42b is located a distance “D2” upwardly from the adjacent digit crotches 28, 30.

FIG. 4A shows the middle finger region 20 in a straight condition. When the person's middle finger “MF” (not shown in FIG. 4A) is inserted into the portion of the interior cavity 10a defined by middle finger region 20, the series of valleys of the undulations, such as valleys 42c, 42d will contact the back of the person's middle finger “MF”. FIG. 4B shows the middle finger region 20 in a bent condition. As is evident from this view, the valleys of the undulations 42, such as valleys 42c, 42d remain in contact with the back of the person's middle finger “MF” and tend to grip onto the same. This gripping action when the middle finger is in the straight condition (FIG. 4A) or the bent condition (FIG. 4B) or moving therebetween tends to keep the back of the middle finger region 20 in a generally static position relative to the middle finger “MF”. This arrangement helps to ensure that tactile sensitivity and fingertip dexterity of the person's middle finger “MF” is maintained when glove 10 is worn.

It will be understood that while glove 10 is illustrated as having each of the thumb region 16, index finger region, middle finger region 20, ring finger region 22, and little finger region 24 including second texture 38 thereon, in other embodiments only one of these digit regions 16-24 may be provided with the second texture 38. In particular, any one of the digit regions 16-24 may be provided with the second texture 38. In another embodiment, any two of the digit regions 16-24 may be provided with the second texture 38. In yet another embodiment, any three of the digit regions 16-24 may be provided with the second texture 38. In yet another embodiment, any four of the digit regions 16-24 may be provided with the second texture 38. In yet a further embodiments, none of the digit regions 16-24 may be provided with the second texture 38.

It will further be understood that while glove 10 is illustrated as having undulations 42 in the rear surface of each of the thumb region 16, index finger region, middle finger region 20, ring finger region 22, and little finger region 24, in other embodiments only one of these digit regions 16-24 may be provided with undulations 42. In particular, any one of the digit regions 16-24 may be provided with undulations 42. In another embodiment, any two of the digit regions 16-24 may be provided with undulations 42. In yet another embodiment, any three of the digit regions 16-24 may be provided with undulations 42. In yet another embodiment, any four of the digit regions 16-24 may be provided with undulations 42. In yet a further embodiments, none of the digit regions 16-24 may be provided with undulations 42.

It will further be understood that while glove 10 is illustrated as including an area of first texture 34 on palm region 14, in other embodiments, the first textured area on palm region 14 may be omitted. In yet other embodiments, the first textured area on palm region 14 may be omitted and fewer than all of the digit regions may be provided with second texture 38 as has been described in the paragraph above. In yet other embodiments, the first textured area on palm region 14 may be omitted and fewer than all of the digit regions may be provided with undulations 42 as has been described in the paragraph above.

Glove 10 may be fabricated from any suitable glove material such as nitrile. In one embodiment, the nitrile glove material is free of or essentially free of zinc and/or sulfur and/or fluoride, and/or cross-links, and/or accelerators and/or accelerants. Some accelerators and/or accelerants which the glove material may be free of or essentially free of may include carbonates or thiurams. The glove material which is free of or essentially free of zinc and/or sulfur and/or fluoride, and/or cross-links, and/or accelerators and/or accelerants will at least comprise a portion of the glove which will contact the user's skin when the glove is worn. The composition of the glove material will therefore tend to reduce hypersensitivity or allergic reactions in people who may be required to frequently or habitually wear protective gloves during the performance of their work.

The glove material preferably is also formulated to be resistant to a variety of toxic or corrosive compounds or chemicals. In one embodiment, for example, the glove material may be resistant to ammonia if the glove 10 is to be used in the meat packing industry. The formulation of the glove material will be selected to best protect a person's hands for any specific application.

Glove 10 preferably is fabricated in a glove material having an exterior surface of one color and an interior surface of another color. Preferably, the first color and the second color are contrasting, particularly strongly contrasting. This difference in color between the interior and exterior surfaces of glove 10 is able act as a tear or cut indicator to a person wearing glove 10. If the person wearing the glove sees the interior second color when viewing the exterior surface of the glove, the person knows that the integrity of the glove is compromised such as by being cut or by being worn away by a corrosive chemical. Consequently, if the interior second color is visible, the person knows it is time for the glove 10 to be discarded and that they should be donning a new pair of gloves.

Glove 10 is manufactured in the following manner. As is customary with the manufacture of gloves from nitrile, a plurality of formers configured to each resemble a human hand and a portion of a human forearm is engaged with a conveying system. In particular, the formers are oriented fingertip down when engaged with the conveying system. One or more vats of liquid nitrile are arranged under portions of the conveying system and the conveying system and formers are progressively dipped into the liquid nitrile. The formers are lifted out of the liquid nitrile and the nitrile is dried, thereby molding the glove on the former. It will be understood that the formers may be dipped a number of times into the liquid nitrile to increase the overall thickness of the glove that is being formed. In accordance with an aspect of the present disclosure, the glove which is being formed is textured with a first texture 34 on only a front surface 14a of the palm region 14 of the glove 10. Additionally, in accordance with an aspect of the present disclosure, the glove 10 which is being formed is additionally textured with a second texture 38 on only the front surface 16a, 18a, 20a, 22a, and 24a of one or more of the digit regions 16-24 of the glove 10.

It will be understood that the first texture 34 may be created on the glove 10 before or after the second texture 38. Additionally, the first texture 34 is created through moving the glove 10 through a first process and the second texture 38 is created through moving the glove 10 through a second process. The first process and second process may be substantially the same as one another or may be completely different from one another. The texturing of the glove 10 in either of the first process or the second process may include providing texturing areas on the former and then producing the first texture 34 or second texture 38 as the former is progressively dipped in the liquid nitrile to mold the glove 10. In other embodiments, the texturing of the glove 10 in either of the first process or the second process may include performing at least part of the texturing process while the glove 10 is being manufactured, for example, between two dipping steps. In yet other embodiments, the texturing of the glove 10 in either of the first process or the second process may including texturing a final one or more layers of the glove material as the nitrile dries on the former or texturing an exterior surface of the glove 10 after the nitrile has dried on the former, or after the glove has been removed from the former.

In one embodiment, the first texture 34 is provided on the palm region 14 through micro-etching the front surface 14a of the glove material through any known process. In so doing, a sand pattern of first texture 34 is formed on front surface 14a of palm region 14. In one embodiment, the second texture 38 is provided on the one or more digit regions through molding or embossing a raised diamond pattern in the front surface 16a, 18a, 20a, 22a, 24a of digit regions 16-24.

The former used for manufacturing glove 10 further includes a plurality of alternating ridges and valleys in the part of the former used to mold the rear surfaces of one or more of the digit regions. As a result, when the former is progressively dipped into liquid nitrile in order to fabricate glove 10, a plurality of gripping zones 42 are molded into the rear surface of at least one of the plurality of digit regions 16-24.

The glove in accordance with the present disclosure is configured for use in industries such as meat packing and other food handling environments. Typically, meat packing plants and other food processing environments are maintained at a relatively cool temperature in order to better preserve the product being processed. The glove in accordance with the present disclosure is able to be worn on its own in any environment, such as in a meat packing plant, or the glove is able to be worn under another glove in a cold environment or any other environment, or is able to be worn over another glove in a cold environment or any other environment.

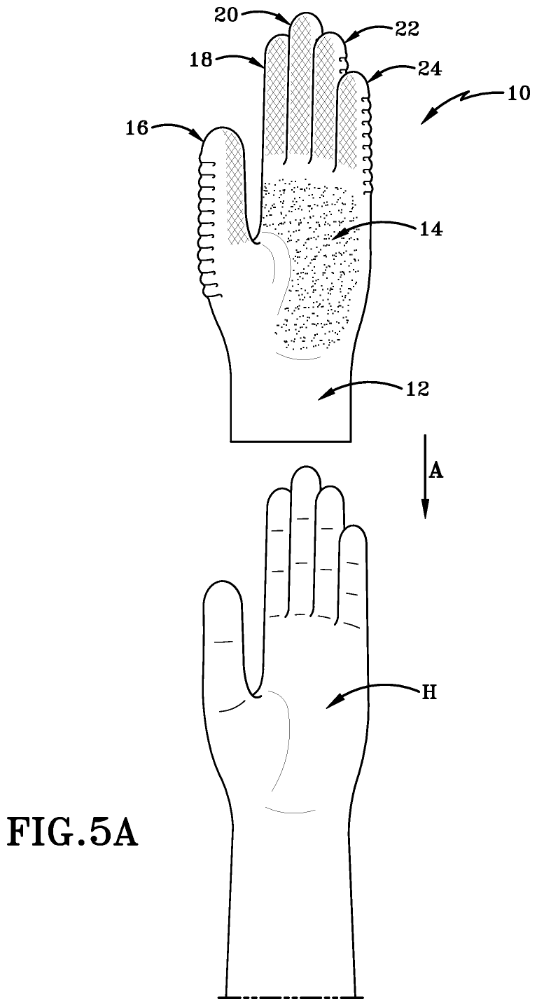

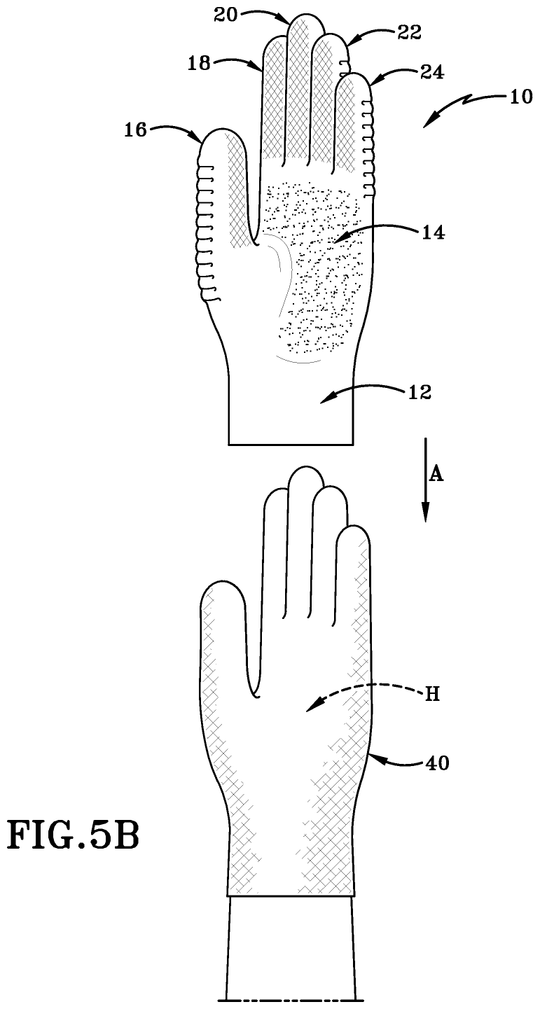

FIG. 5A is a first operational view showing glove 10 in use. Glove 10 is shown oriented over a person's left hand “H” in a suitable position for glove 10 to be donned on the hand “H”. Hand “H” is bare, i.e., nothing is covering the person's skin. As is evident from the figure, glove 10 will be moved downwardly in the direction “A” when a person is donning glove 10 and will be moved in the opposite direction to glove “A” to doff glove 10, i.e., to remove the glove 10 from over hand “H”.

FIG. 5B is a second operational view showing glove 10 in use. Glove is shown oriented over a person's left hand “H” in a suitable position for glove 10 to be donned over the hand “H”. In this particular instance, hand “H” is not bare but is, instead, covered by another glove 40. Glove 40 is in direct contact with the person's bare skin. Glove 40, in some embodiments, has different characteristics to glove 10. For example, glove 40 may be a lightweight cotton liner or a cut-resistant glove, or a waterproof glove, or a heat-proof or cold-proof glove. In other words, glove 40 may be fabricated from a material that is soft on the hands and potentially soaks up moisture from sweat. Alternatively, glove 40 may be fabricated from a strong protective material which substantially prevents sharp knives or sharp implements from penetrating the glove material. Still further, glove 40 may be fabricated from a glove material having insulating properties and those properties may protect the person's hand “H” from heat and/or cold. Glove 40 is configured to more closely conform to the person's hand “H” and glove 10 is configured to fit over an exterior surface of glove 40. Each of glove 40 and glove 10 provides different features which protect the hand “H” differently. Glove 10, as described earlier herein aids a person to grip objects in their hand “H” more reliably because of the various textures provided on the surfaces of the glove 10 which will contact an object gripped in the hand “H” while wearing glove 10.

Although not illustrated herein, glove 10 may be worn over the person's bare hand “H” as in FIG. 5A or over another glove 40, as in FIG. 5B, and then yet another glove (not shown) may be pulled over the exterior surface of glove 10 in either instance. The additional glove that is donned over the exterior surface of glove 10 may be identical to glove 10 or may be different from glove 10. Double-gloving (as when another glove is pulled over the glove 10 shown in FIG. 5A) or triple-gloving (as when another glove is pulled over the glove 10 shown in FIG. 5B) adds additional protective features to the person's hand “H”. The specific protections offered by the double-gloving or triple gloving will depend on the materials of the gloves in question.

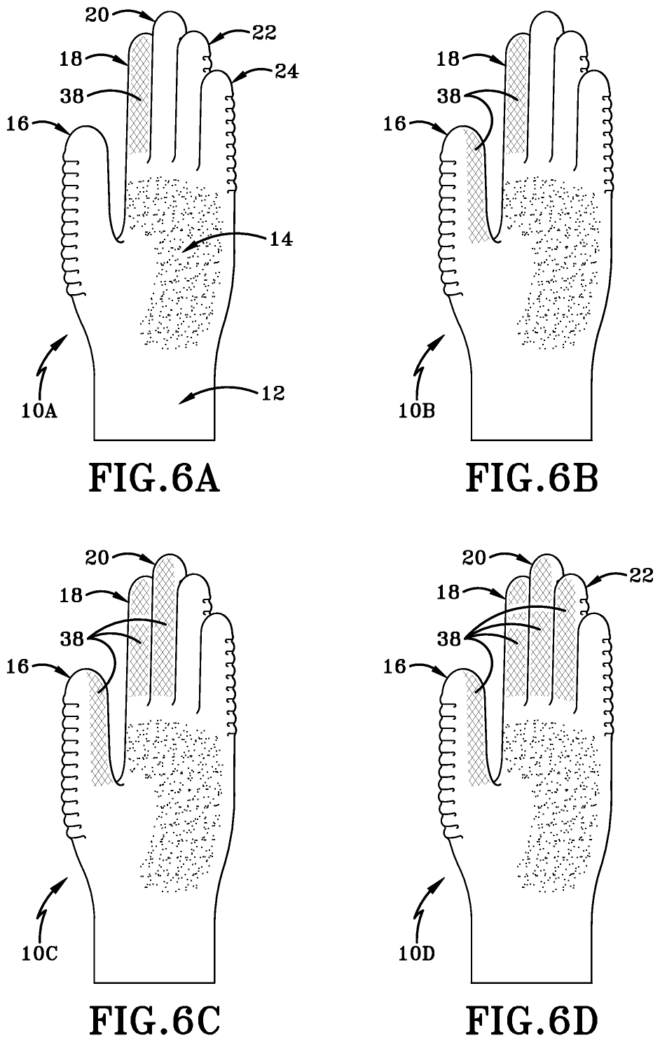

Referring now to FIGS. 6A to 6D, there are shown additional examples of the first embodiment glove 10 in accordance with the present disclosure.

FIG. 6A shows a second example of the first embodiment of the glove in accordance with the present disclosure, generally indicated as glove 10A. Glove 10A is identical to glove 10 in every aspect relating to structure and function except that instead of all digit of the digit regions being textured on their front surfaces, only index finger region 18 includes second texture 38. The front surfaces of all other digit regions 16, 20, 22, and 24 are smooth and free of texturing. It should be understood that while FIG. 6A shows that index finger region 18 is the only digit region with second texture 38 thereon, in other embodiments any other single digit region may be provided with second texture 38 instead of index finger region 18. For example, only little finger region 24 may including second texture 38.

FIG. 6B shows a third example of the first embodiment of the glove in accordance with the present disclosure, generally indicated as glove 10B. Glove 10B is identical to glove 10 in every aspect relating to structure and function except that instead of the front surfaces of all digit regions being textured with second texture 38, only index finger region 18 and thumb region 16 have front surfaces with second texture 38 thereon. The front surfaces of all other digit regions on glove 10B are smooth and free of the texturing. It will be understood that while FIG. 6B shows thumb region 16 and index finger region 18 including second texture 38 on the front surfaces thereof, in other embodiments any other combination of two digit regions instead of thumb region 16 and index finger region 18 may have front surfaces with second texture 38 thereon. For example, thumb region 16 and ring finger region 20 may have front surfaces with second texture 38 thereon.

FIG. 6C shows a fourth example of the first embodiment of the glove in accordance with the present disclosure, generally indicated as glove 10C. Glove 10C is identical to glove 10 in every aspect relating to structure and function except that instead of the front surfaces of all digit regions being textured, only thumb region 16, index finger region 18 and middle finger region 20 have front surfaces with second texture 38 thereon. The front surfaces of the other digit regions are smooth and free of texture. It will be understood that while FIG. 6C shows thumb region 16, index finger region 18, and middle finger region 20 as the three digit regions with second texture 38 on the front surfaces thereof, in other embodiments the front surfaces of any other combination of three digit regions may be textured with second texture 38 instead of thumb region 16, index finger region 18, and middle finger region 20.

FIG. 6D shows a fifth example of the first embodiment of the glove in accordance with the present disclosure, generally indicated as glove 10D. Glove 10D is identical to glove 10 in every aspect relating to structure and function except that instead of the front surfaces of all digit regions being textured with second texture 38, only thumb region 16, index finger region 18, middle finger region 20, and ring finger region 22 have front surfaces with second texture 38 thereon. The front surface of little finger region 24 is smooth and free of texture. It will be understood that while FIG. 6D shows thumb region 16, index finger region 18, middle finger region 20, and ring finger region 22 as the four digit regions with textured front surfaces, in other embodiments the front surfaces of any other combination of four digit regions may be textured with second texture 38 instead of thumb region 16, index finger region 18, middle finger region 20, and ring finger region 22.

It will be understood that the decision as to which of the digit regions 16, 18, 20, 22, 24 will be textured on any of gloves 10A, 10B, 10C, and 10D may be based on the end use of the particular example of the first embodiment of the glove.

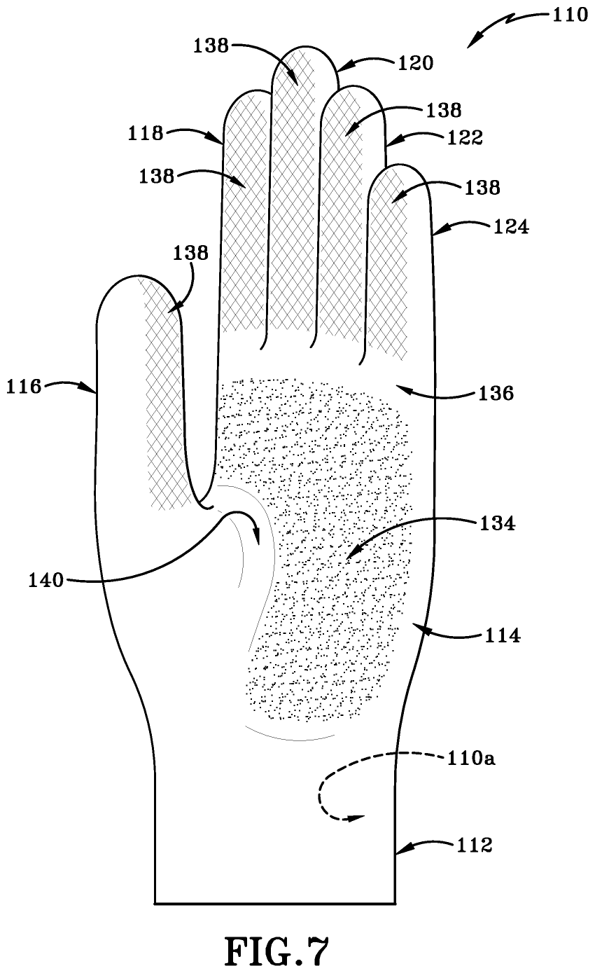

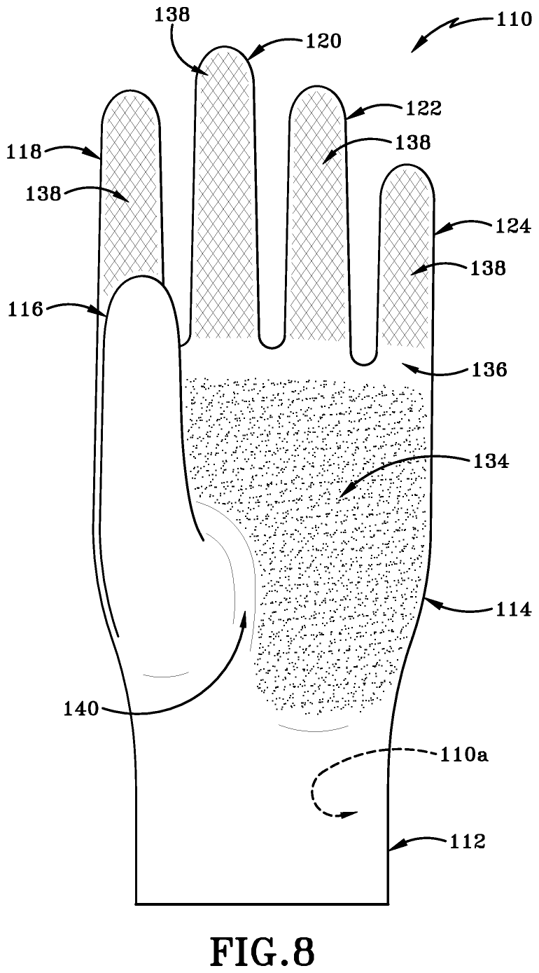

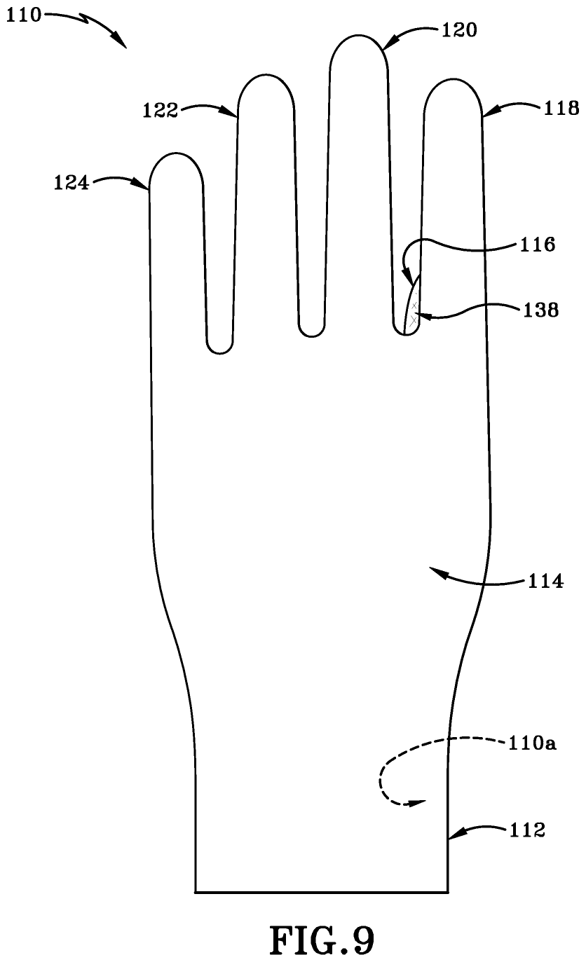

Referring now to FIGS. 7-9 there is shown a first example of a second embodiment of a glove in accordance with an aspect of the present disclosure, generally indicated at 110. Glove 110 comprises a wrist region 112, a palm region 114, a thumb region 116, an index finger region 118, a middle finger region 120, a ring finger region 122, and a little finger region 124. Glove 110 defines an interior cavity 110a which is configured to receive a hand of a person therein. Thumb region 116, index finger region 118, middle finger region 120, ring finger region 122, and little finger region 124 comprise digit regions which extend outwardly from palm region. The digit regions are configured to receive an associated one of a thumb, an index finger, a middle finger, a ring finger, and a little finger of the person's hand, respectively.

Glove 110 is substantially identical in structure and function to glove 10 except for the features which will be described later herein. As such glove 110 is a hand-specific glove configured to be worn on the left hand of a person. Glove 110 is provided with a first texture 134 on a front surface of palm region 114. The first texture 134 is provided in a substantially identical pattern on glove 110 as is first texture 34 on glove 10. Similarly, glove 110 includes two regions free of texture, generally indicated at 136 and 140 which are provided in a substantially identical location on glove 110 as are texture-free regions 36 and 40 on glove 10. Glove 110 further includes a second texture 138 on the front surfaces of each of the thumb region 116, index finger region 118, middle finger region 120, ring finger region 122, and little finger region 124. The second texture 138 is provided on glove 110 in substantially identical locations to the second texture 38 on glove 10. The first texture 134 is substantially identical to first texture 34 and the second texture 138 is substantially identical to second texture 38. The rest of the glove 110 is substantially smooth and free of texture.

Glove 110 differs from glove 10 in that the rear surfaces of all of the digit regions are free of any undulations. In other words, there are no undulations similar or identical to undulations 42 on any of the digit regions 116, 118, 120, 122, 124.

Glove 110 is used in a substantially identical manner to glove 10.

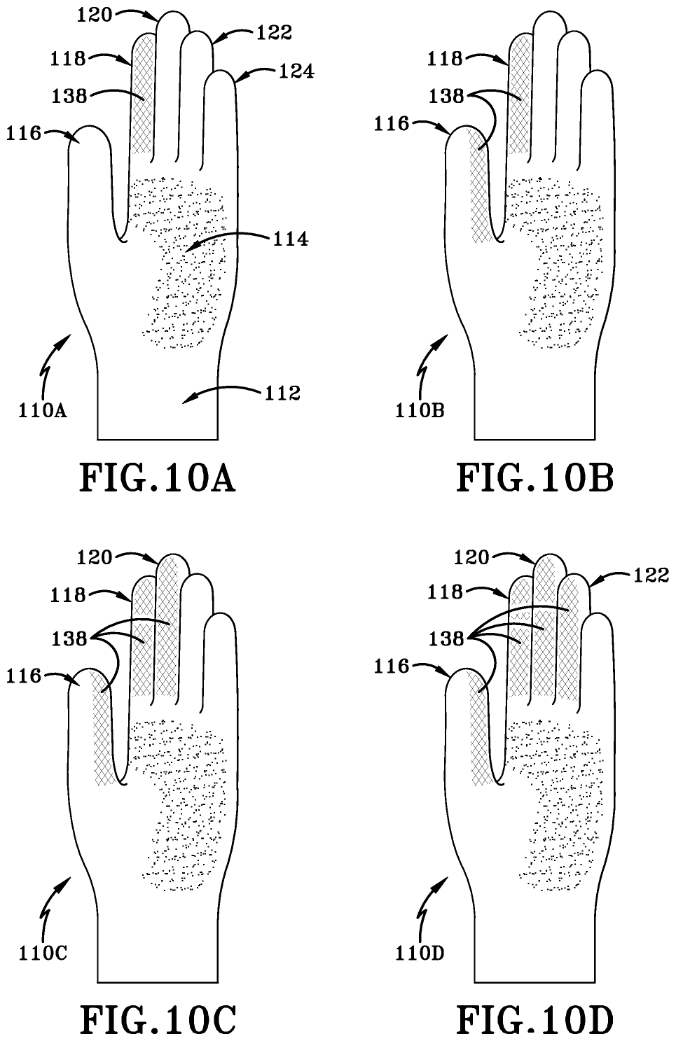

Referring now to FIGS. 10A to 10D, there are shown additional examples of the second embodiment glove 110 in accordance with the present disclosure.

FIG. 10A shows a second example of the second embodiment of the glove in accordance with the present disclosure, generally indicated as glove 110A. Glove 110A is identical to glove 110 in every aspect relating to structure and function except that instead of all digit of the digit regions being textured on their front surfaces, only index finger region 118 includes second texture 138. The front surfaces of all other digit regions 116, 120, 122, and 124 are smooth and free of texturing. It should be understood that while FIG. 10A shows that index finger region 118 is the only digit region with second texture 138 thereon, in other embodiments any other single digit region may be provided with second texture 138 instead of index finger region 118. For example, only little finger region 124 may including second texture 138.

FIG. 10B shows a third example of the second embodiment of the glove in accordance with the present disclosure, generally indicated as glove 110B. Glove 110B is identical to glove 110 in every aspect relating to structure and function except that instead of the front surfaces of all digit regions being textured with second texture 138, only index finger region 118 and thumb region 116 have front surfaces with second texture 138 thereon. The front surfaces of all other digit regions on glove 110B are smooth and free of the texturing. It will be understood that while FIG. 10B shows thumb region 116 and index finger region 118 including second texture 138 on the front surfaces thereof, in other embodiments any other combination of two digit regions instead of thumb region 116 and index finger region 118 may have front surfaces with second texture 138 thereon. For example, thumb region 116 and ring finger region 120 may have front surfaces with second texture 138 thereon.

FIG. 10C shows a fourth example of the second embodiment of the glove in accordance with the present disclosure, generally indicated as glove 110C. Glove 110C is identical to glove 110 in every aspect relating to structure and function except that instead of the front surfaces of all digit regions being textured, only thumb region 116, index finger region 118 and middle finger region 120 have front surfaces with second texture 138 thereon. The front surfaces of the other digit regions are smooth and free of texture. It will be understood that while FIG. 10C shows thumb region 116, index finger region 118, and middle finger region 120 as the three digit regions with second texture 138 on the front surfaces thereof, in other embodiments the front surfaces of any other combination of three digit regions may be textured with second texture 138 instead of thumb region 116, index finger region 118, and middle finger region 120.

FIG. 10D shows a fifth example of the second embodiment of the glove in accordance with the present disclosure, generally indicated as glove 110D. Glove 110D is identical to glove 110 in every aspect relating to structure and function except that instead of the front surfaces of all digit regions being textured with second texture 138, only thumb region 116, index finger region 118, middle finger region 120, and ring finger region 122 have front surfaces with second texture 138 thereon. The front surface of little finger region 124 is smooth and free of texture. It will be understood that while FIG. 10D shows thumb region 116, index finger region 118, middle finger region 120, and ring finger region 122 as the four digit regions with textured front surfaces, in other embodiments the front surfaces of any other combination of four digit regions may be textured with second texture 138 instead of thumb region 116, index finger region 118, middle finger region 120, and ring finger region 122.

It will be understood that the decision as to which of the digit regions 116, 118, 120, 122, 124 will be textured on any of gloves 110A, 110B, 110C, and 110D may be based on the end use of the particular example of the second embodiment of the glove.

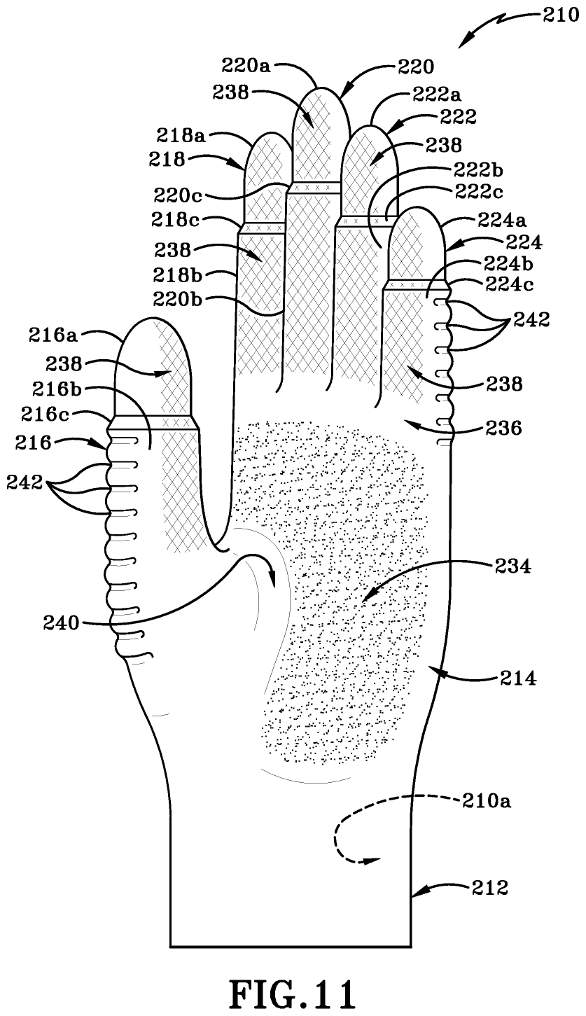

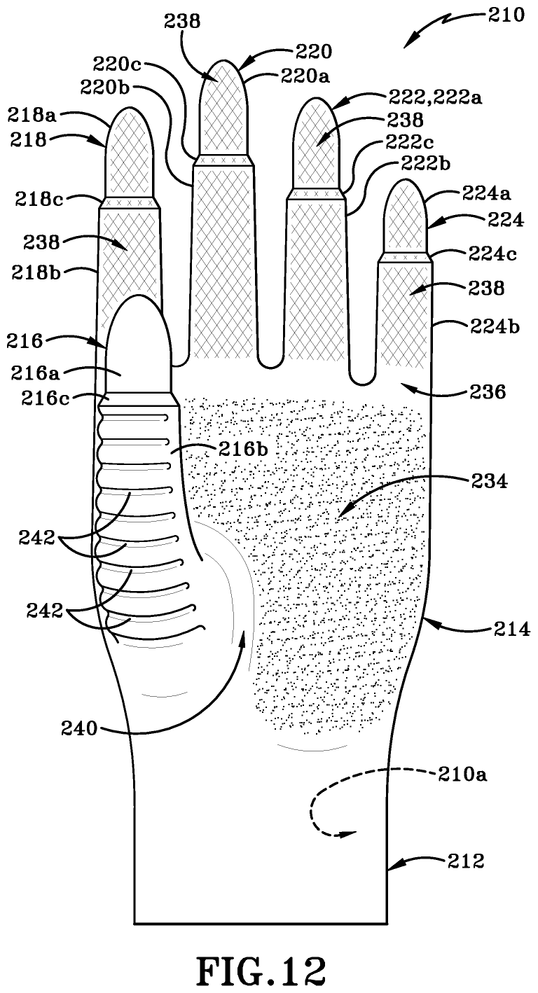

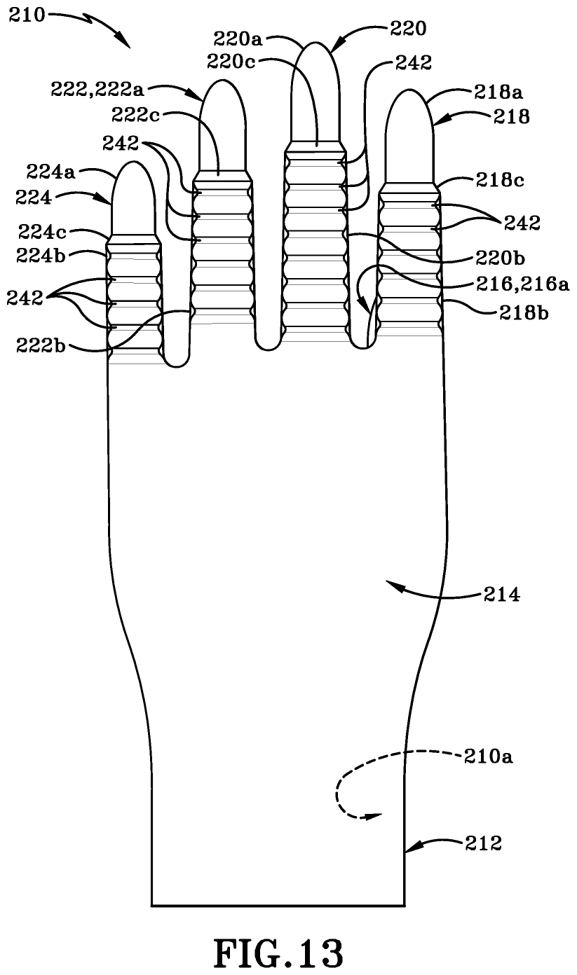

Referring now to FIGS. 11-13 there is shown a first example of a third embodiment of a glove in accordance with an aspect of the present disclosure, generally indicated at 210. Glove 210 comprises a wrist region 212, a palm region 214, a thumb region 216, an index finger region 218, a middle finger region 220, a ring finger region 222, and a little finger region 224. Glove 210 defines an interior cavity 210a which is configured to receive a hand of a person therein. Thumb region 216, index finger region 218, middle finger region 220, ring finger region 222, and little finger region 224 comprise digit regions which extend outwardly from palm region 214. The digit regions are configured to receive an associated one of a thumb, an index finger, a middle finger, a ring finger, and a little finger of the person's hand, respectively.

Glove 210 is substantially identical in structure and function to glove 10 except for the features which will be described later herein. As such glove 210 is a hand-specific glove configured to be worn on the left hand of a person. Glove 210 is provided with a first texture 234 on a front surface of palm region 214. The first texture 234 is provided in a substantially identical pattern on glove 210 as is first texture 34 on glove 10. Similarly, glove 210 includes two regions free of texture, generally indicated at 236 and 240 which are provided in a substantially identical location on glove 210 as are texture-free regions 36 and 40 on glove 10. Glove 210 further includes a second texture 238 on the front surfaces of each of the thumb region 216, index finger region 218, middle finger region 220, ring finger region 222, and little finger region 224. The second texture 238 is provided on glove 210 in substantially identical locations to the second texture 38 on glove 10. The first texture 234 is substantially identical to first texture 34 and the second texture 238 is substantially identical to second texture 38. The rest of the glove 210 is substantially smooth and free of texture. Substantially identically to glove 10, glove 210 includes a plurality of undulations 242 formed in the glove material of the rear surfaces of each of the digit regions 216, 218, 220, 222, and 224.

Glove 210 differs from glove 10 in that each of the digit regions 216, 218, 220, 222, 224 includes a fingertip region of a reduced circumference relative to a remaining portion of the associated digit region. In accordance with an aspect of the third embodiment glove 210, a transition region extends between the fingertip region and the remaining portion of each digit region. The transition region tapers in circumference from the remaining portion of the associated digit region to the reduced circumference of the fingertip region. As illustrated, the fingertip region provided on each digit region is of a bullet-tip shape. Thumb region 216 includes a fingertip region 216a, a remaining portion 216b, and a transition region 216c. Index finger region 218 includes a fingertip region 218a, a remaining portion 218b, and a transition region 218c. Middle finger region 220 includes a fingertip region 220a, a remaining portion 220b, and a transition region 220c. Ring finger region 222 includes a fingertip region 222a, a remaining portion 222b, and a transition region 222c. Finally, little finger region 224 includes a fingertip region 224a, a remaining portion 224b, and a transition region 224c. The reduced circumference of the fingertip regions 216a, 218a, 220a, 222a, and 224a ensures that glove 210 closely conforms to the fingertips of the person's hand and thereby helps to ensure the person's tactile sensitivity and finger and thumb dexterity is maintained even while glove 210 is worn.

The provision of the reduced circumference fingertip regions and transitions regions on the digit regions of glove 210 is in contrast to the substantially constant circumference digit regions of glove 10. The glove 10 has digit regions which very gradually taper in circumference.

In accordance with an aspect of glove 210, second texture 238 is provided on the front surfaces of each of the digit regions including the fingertip regions, remaining portions, and transition regions thereof. It will be understood that in other embodiments, second texture 238 may be omitted from one or more of the fingertip regions, the transitions regions, and remaining portions of the glove 210.

Glove 210 is used in a substantially identical manner to glove 10.

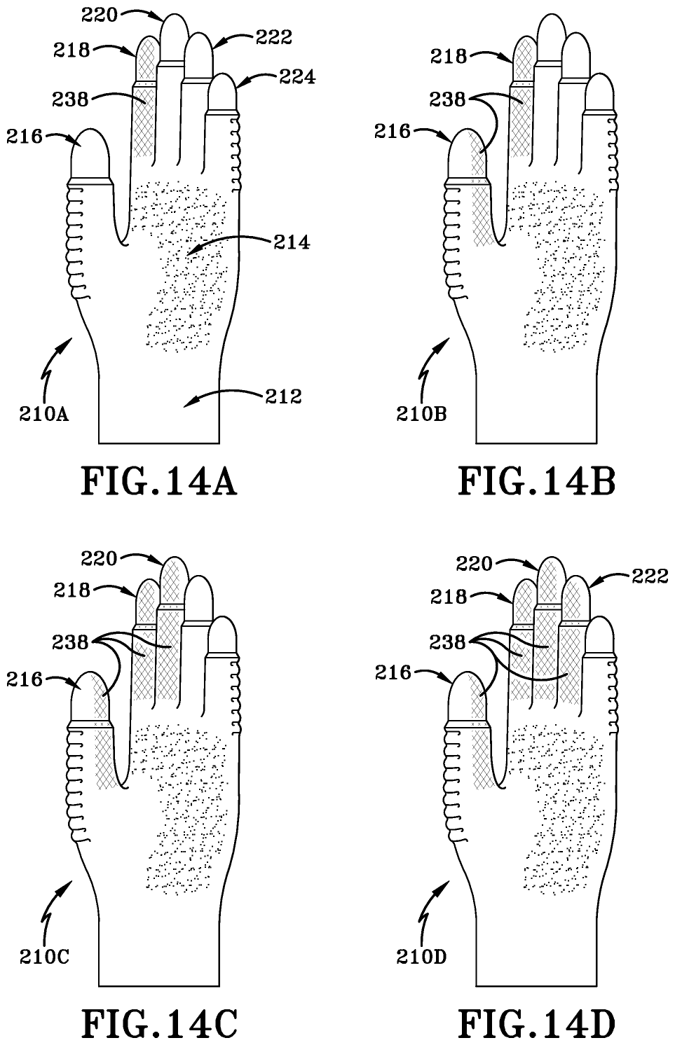

Referring now to FIGS. 14A to 14D, there are shown additional examples of the third embodiment glove 210 in accordance with the present disclosure.

FIG. 14A shows a second example of the third embodiment of the glove in accordance with the present disclosure, generally indicated as glove 210A. Glove 210A is identical to glove 210 in every aspect relating to structure and function except that instead of all digit of the digit regions being textured on their front surfaces, only index finger region 218 includes second texture 238. The front surfaces of all other digit regions 216, 220, 222, and 224 are smooth and free of texturing. It should be understood that while FIG. 14A shows that index finger region 218 is the only digit region with second texture 238 thereon, in other embodiments any other single digit region may be provided with second texture 238 instead of index finger region 218. For example, only little finger region 224 may including second texture 238.

FIG. 14B shows a third example of the third embodiment of the glove in accordance with the present disclosure, generally indicated as glove 210B. Glove 210B is identical to glove 210 in every aspect relating to structure and function except that instead of the front surfaces of all digit regions being textured with second texture 238, only index finger region 218 and thumb region 216 have front surfaces with second texture 238 thereon. The front surfaces of all other digit regions on glove 210B are smooth and free of the texturing. It will be understood that while FIG. 14B shows thumb region 216 and index finger region 218 including second texture 238 on the front surfaces thereof, in other embodiments any other combination of two digit regions instead of thumb region 216 and index finger region 218 may have front surfaces with second texture 238 thereon. For example, thumb region 216 and ring finger region 220 may have front surfaces with second texture 238 thereon.

FIG. 14C shows a fourth example of the third embodiment of the glove in accordance with the present disclosure, generally indicated as glove 210C. Glove 210C is identical to glove 210 in every aspect relating to structure and function except that instead of the front surfaces of all digit regions being textured, only thumb region 216, index finger region 218 and middle finger region 220 have front surfaces with second texture 238 thereon. The front surfaces of the other digit regions are smooth and free of texture. It will be understood that while FIG. 14C shows thumb region 216, index finger region 218, and middle finger region 220 as the three digit regions with second texture 238 on the front surfaces thereof, in other embodiments the front surfaces of any other combination of three digit regions may be textured with second texture 238 instead of thumb region 216, index finger region 218, and middle finger region 220.

FIG. 14D shows a fifth example of the third embodiment of the glove in accordance with the present disclosure, generally indicated as glove 210D. Glove 210D is identical to glove 210 in every aspect relating to structure and function except that instead of the front surfaces of all digit regions being textured with second texture 238, only thumb region 216, index finger region 218, middle finger region 220, and ring finger region 222 have front surfaces with second texture 238 thereon. The front surface of little finger region 224 is smooth and free of texture. It will be understood that while FIG. 14D shows thumb region 216, index finger region 218, middle finger region 220, and ring finger region 222 as the four digit regions with textured front surfaces, in other embodiments the front surfaces of any other combination of four digit regions may be textured with second texture 238 instead of thumb region 216, index finger region 218, middle finger region 220, and ring finger region 222.

It will be understood that the decision as to which of the digit regions 216, 218, 220, 222, 224 will be textured on any of gloves 210A, 210B, 210C, and 210D may be based on the end use of the particular example of the third embodiment of the glove.

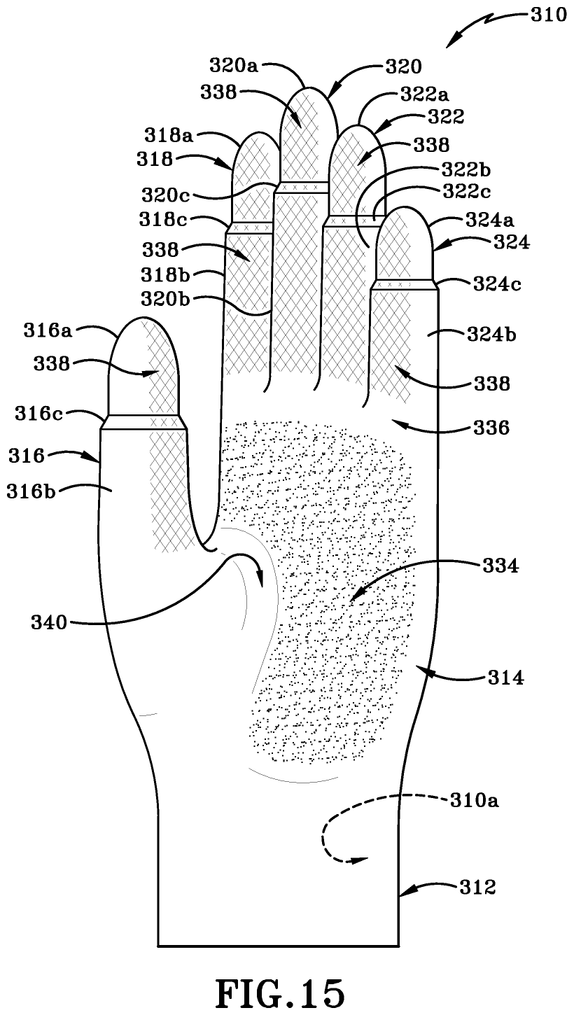

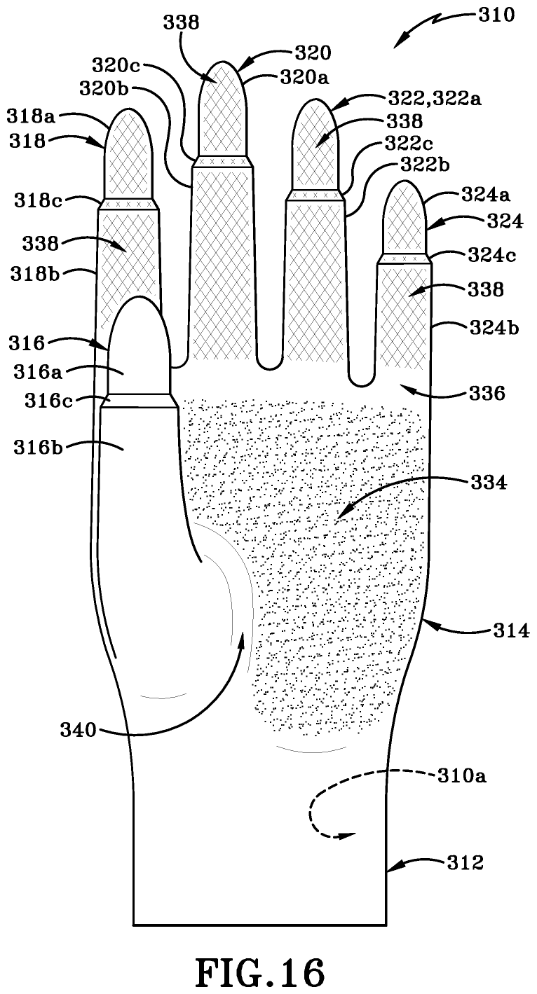

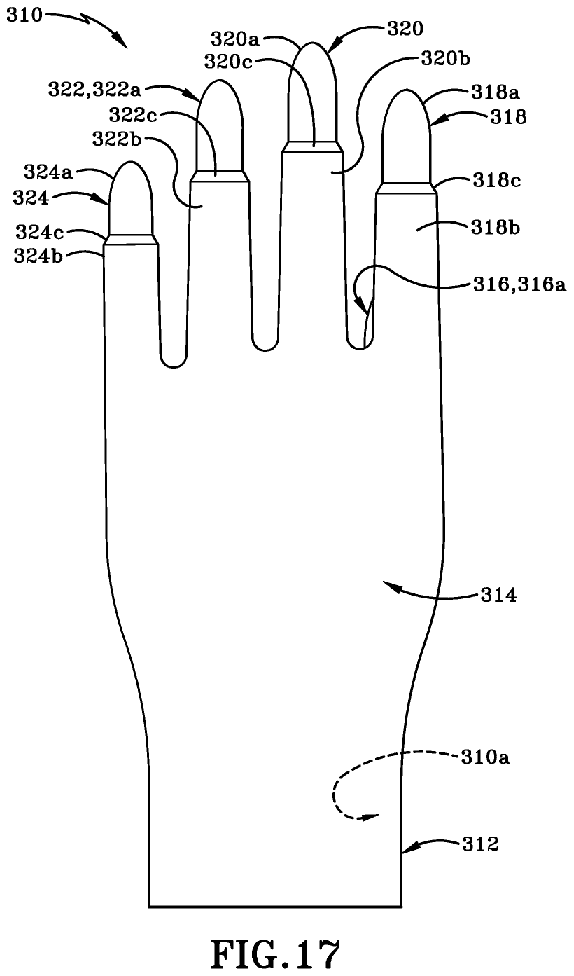

Referring now to FIGS. 15-17 there is shown a first example of a fourth embodiment of a glove in accordance with an aspect of the present disclosure, generally indicated at 310. Glove 310 comprises a wrist region 312, a palm region 314, a thumb region 316, an index finger region 318, a middle finger region 320, a ring finger region 322, and a little finger region 324. Glove 310 defines an interior cavity 310a which is configured to receive a hand of a person therein. Thumb region 316, index finger region 318, middle finger region 320, ring finger region 322, and little finger region 324 comprise digit regions which extend outwardly from palm region 314. The digit regions are configured to receive an associated one of a thumb, an index finger, a middle finger, a ring finger, and a little finger of the person's hand, respectively.

Glove 310 is substantially identical in structure and function to glove 210 except for the features which will be described later herein. As such glove 310 is a hand-specific glove configured to be worn on the left hand of a person. Glove 310 is provided with a first texture 334 on a front surface of palm region 314. The first texture 334 is provided in a substantially identical pattern on glove 310 as is first texture 34 on glove 210. Similarly, glove 310 includes two regions free of texture, generally indicated at 336 and 340 which are provided in a substantially identical location on glove 310 as are texture-free regions 36 and 40 on glove 210. Glove 310 further includes a second texture 338 on the front surfaces of each of the thumb region 316, index finger region 318, middle finger region 320, ring finger region 322, and little finger region 324. The second texture 338 is provided on glove 310 in substantially identical locations to the second texture 38 on glove 210. The first texture 334 is substantially identical to first texture 234 and the second texture 338 is substantially identical to second texture 238. The rest of the glove 310 is substantially smooth and free of texture.

Glove 310 is substantially identical to glove 210 in that each of the digit regions 316, 318, 320, 322, 324 includes a fingertip region of a reduced circumference relative to a remaining portion of the associated digit region. In accordance with a further aspect of glove 310, a transition region extends between the fingertip region and the remaining portion of each digit region. The transition region tapers in circumference from the remaining portion of the associated digit region to the reduced circumference of the fingertip region. As illustrated, the fingertip region provided on each digit region is of a bullet-tip shape. As shown in FIG. 15, Thumb region 316 includes a fingertip region 316a, a remaining portion 316b, and a transition region 316c. Index finger region 318 includes a fingertip region 318a, a remaining portion 318b, and a transition region 318c. Middle finger region 320 includes a fingertip region 320a, a remaining portion 320b, and a transition region 320c. Ring finger region 322 includes a fingertip region 322a, a remaining portion 322b, and a transition region 322c. Finally, little finger region 324 includes a fingertip region 324a, a remaining portion 324b, and a transition region 324c. The reduced circumference of the fingertip regions 316a, 318a, 320a, 322a, and 324a ensures that glove 310 closely conforms to the fingertips of the person's hand and thereby helps to ensure the person's tactile sensitivity and finger and thumb dexterity is maintained even while glove 310 is worn.

Glove 310 differs from glove 210 in that the rear surfaces of each of the digit regions 316, 318, 320, 322, and 324 are free of any undulations. In other words, glove 310 does not include undulations such as the undulations 242 provided on glove 210.

In accordance with an aspect of glove 310, second texture 338 is provided on the front surfaces of each of the digit regions including the remaining portions, fingertip regions, and transition regions thereof. It will be understood that in other embodiments, second texture 338 may be omitted from one or more of the fingertip regions, the transitions regions, and remaining portions of the glove 310.

Glove 310 is used in a substantially identical manner to glove 210.

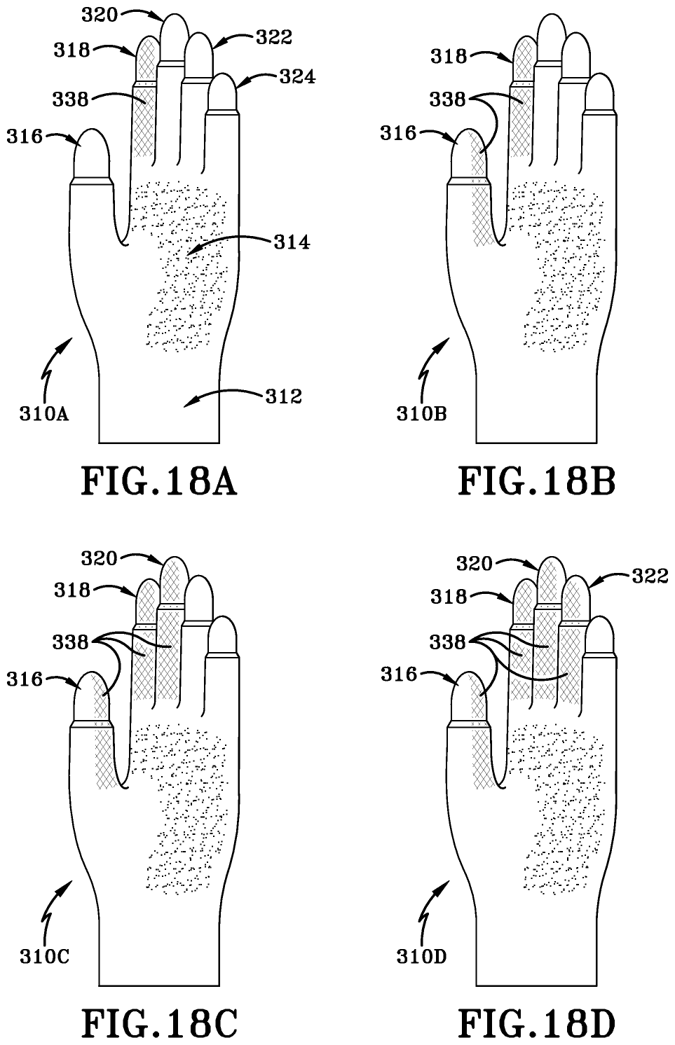

Referring now to FIGS. 18A to 18D, there are shown additional examples of the fourth embodiment glove 310 in accordance with the present disclosure.

FIG. 18A shows a second example of the fourth embodiment of the glove in accordance with the present disclosure, generally indicated as glove 310A. Glove 310A is identical to glove 310 in every aspect relating to structure and function except that instead of all digit of the digit regions being textured on their front surfaces, only index finger region 318 includes second texture 338. The front surfaces of all other digit regions 316, 320, 322, and 324 are smooth and free of texturing. It should be understood that while FIG. 18A shows that index finger region 318 is the only digit region with second texture 338 thereon, in other embodiments any other single digit region may be provided with second texture 338 instead of index finger region 318. For example, only little finger region 324 may including second texture 338.

FIG. 18B shows a third example of the fourth embodiment of the glove in accordance with the present disclosure, generally indicated as glove 310B. Glove 310B is identical to glove 310 in every aspect relating to structure and function except that instead of the front surfaces of all digit regions being textured with second texture 338, only index finger region 318 and thumb region 316 have front surfaces with second texture 338 thereon. The front surfaces of all other digit regions on glove 310B are smooth and free of the texturing. It will be understood that while FIG. 18B shows thumb region 316 and index finger region 318 including second texture 338 on the front surfaces thereof, in other embodiments any other combination of two digit regions instead of thumb region 316 and index finger region 318 may have front surfaces with second texture 338 thereon. For example, thumb region 316 and ring finger region 320 may have front surfaces with second texture 338 thereon.

FIG. 18C shows a fourth example of the fourth embodiment of the glove in accordance with the present disclosure, generally indicated as glove 310C. Glove 310C is identical to glove 310 in every aspect relating to structure and function except that instead of the front surfaces of all digit regions being textured, only thumb region 316, index finger region 318 and middle finger region 320 have front surfaces with second texture 338 thereon. The front surfaces of the other digit regions are smooth and free of texture. It will be understood that while FIG. 18C shows thumb region 316, index finger region 318, and middle finger region 320 as the three digit regions with second texture 338 on the front surfaces thereof, in other embodiments the front surfaces of any other combination of three digit regions may be textured with second texture 338 instead of thumb region 316, index finger region 318, and middle finger region 320.

FIG. 18D shows a fifth example of the fourth embodiment of the glove in accordance with the present disclosure, generally indicated as glove 310D. Glove 310D is identical to glove 310 in every aspect relating to structure and function except that instead of the front surfaces of all digit regions being textured with second texture 338, only thumb region 316, index finger region 318, middle finger region 320, and ring finger region 322 have front surfaces with second texture 338 thereon. The front surface of little finger region 324 is smooth and free of texture. It will be understood that while FIG. 18D shows thumb region 316, index finger region 318, middle finger region 320, and ring finger region 322 as the four digit regions with textured front surfaces, in other embodiments the front surfaces of any other combination of four digit regions may be textured with second texture 338 instead of thumb region 316, index finger region 318, middle finger region 320, and ring finger region 322.

It will be understood that the decision as to which of the digit regions 316, 318, 320, 322, 324 will be textured on any of gloves 310A, 310B, 310C, and 310D may be based on the end use of the particular example of the fourth embodiment of the glove.

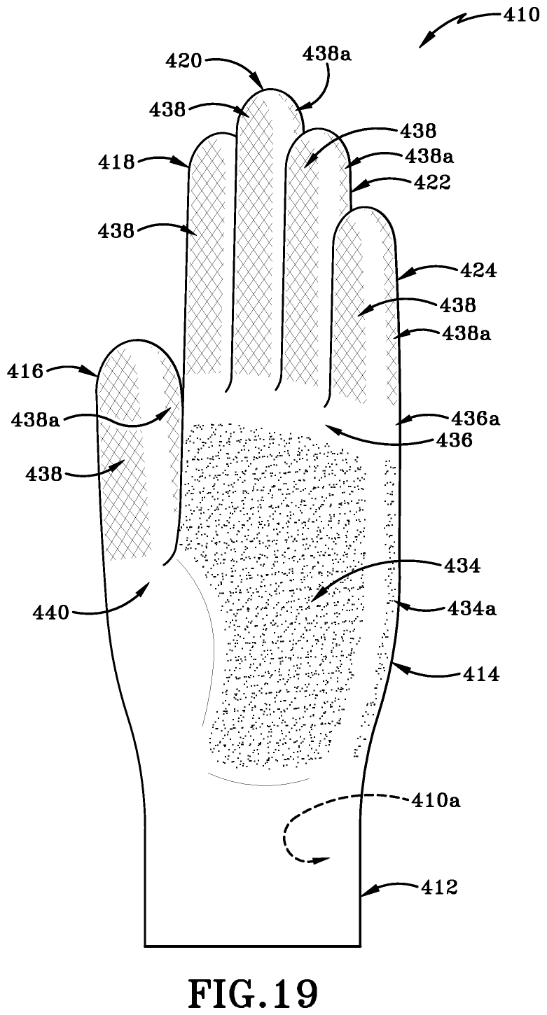

Referring now to FIGS. 19-21 there is shown a first example of a fifth embodiment of a glove in accordance with an aspect of the present disclosure, generally indicated at 410. Glove 410 comprises a wrist region 412, a palm region 414, a thumb region 416, an index finger region 418, a middle finger region 420, a ring finger region 422, and a little finger region 424. Glove 410 defines an interior cavity 410a which is configured to receive a hand of a person therein. Thumb region 416, index finger region 418, middle finger region 420, ring finger region 422, and little finger region 424 comprise digit regions which extend outwardly from palm region. The digit regions are configured to receive an associated one of a thumb, an index finger, a middle finger, a ring finger, and a little finger of the person's hand, respectively.

Glove 410 is substantially identical in structure and function to glove 110 except for the features which will be described later herein. Glove 110 is a hand-specific glove whereas glove 410 is an ambidextrous glove. As such glove 410 is configured to be able to be worn on either of the left hand or the right hand of a person. Because glove 410 is an ambidextrous glove, all of the digit regions 416, 418, 420, 422, and 424 will be aligned along a common plane.

Glove 410 is provided with a first texture 434 on a front surface of palm region 414. The first texture 434 is provided in a substantially identical pattern on glove 410 as is first texture 134 on glove 110. Similarly, glove 410 includes two regions free of texture, generally indicated at 436 and 440 which are provided in a substantially identical location on glove 410 as are texture-free regions 136 and 140 on glove 110. Glove 410 further includes a second texture 438 on the front surfaces of each of the thumb region 416, index finger region 418, middle finger region 420, ring finger region 422, and little finger region 424. The second texture 438 is provided on glove 410 in substantially identical locations to the second texture 138 on glove 110. The first texture 434 is substantially identical to first texture 134 and the second texture 438 is substantially identical to second texture 138.

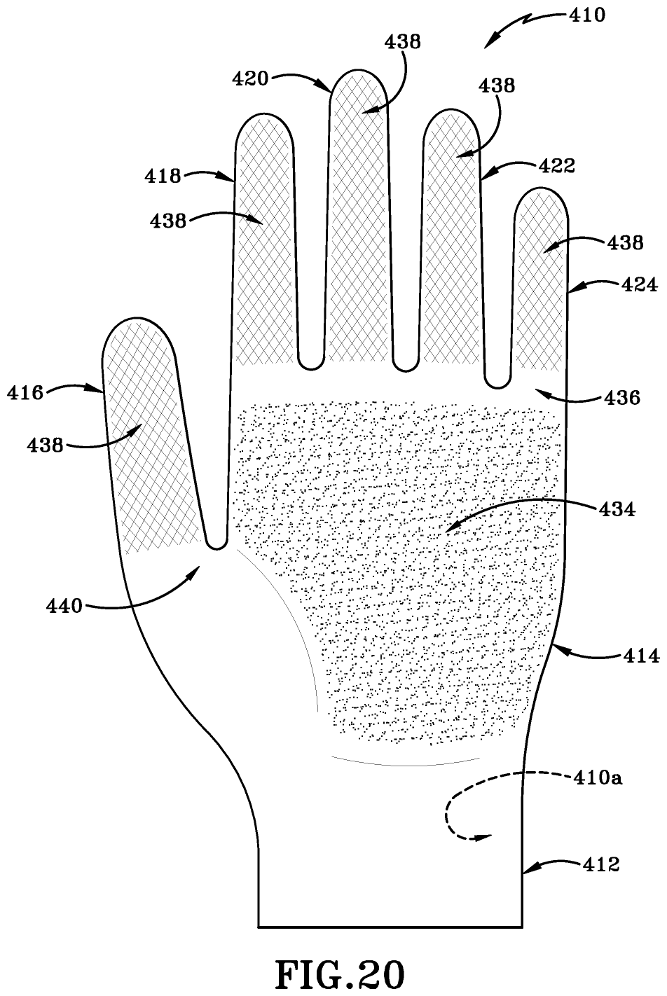

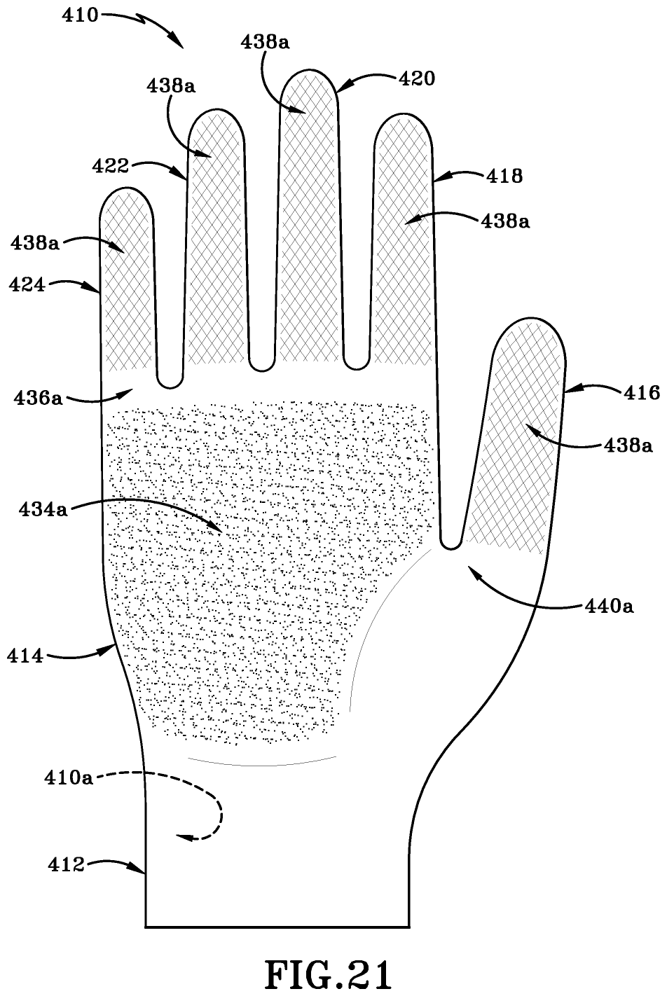

As indicated above, glove 410 is an ambidextrous glove and therefore a front surface of the glove 410, shown in FIG. 20, is identical to a rear surface of the glove, shown in FIG. 21. Glove 410 is provided with a first texture 434a on the rear surface of palm region 414. The first texture 434a is provided in a substantially identical pattern on glove 410 as is first texture 434. Similarly, glove 410 includes two regions free of texture, generally indicated at 436a and 440a which are provided in a substantially identical location on the rear surface of glove 410 as are the texture-free regions 436 and 440 on the front surface of glove 410. Glove 410 further includes a second texture 438a on the rear surfaces of each of the thumb region 416, index finger region 418, middle finger region 420, ring finger region 422, and little finger region 424. The second texture 438a is provided on the rear surfaces of the digit regions of glove 410 in substantially identical locations to the second texture 438 provided on the front surfaces of the digit regions of glove 410. The rest of the glove 410 is substantially smooth and free of texture.

Glove 410 additionally differs from glove 10 in that the rear surfaces of all of the digit regions are free of any undulations. In other words, there are no undulations similar or identical to undulations 42 on any of the digit regions 416, 418, 420, 422, 424.

Glove 410 is used in a substantially identical manner to glove 10.

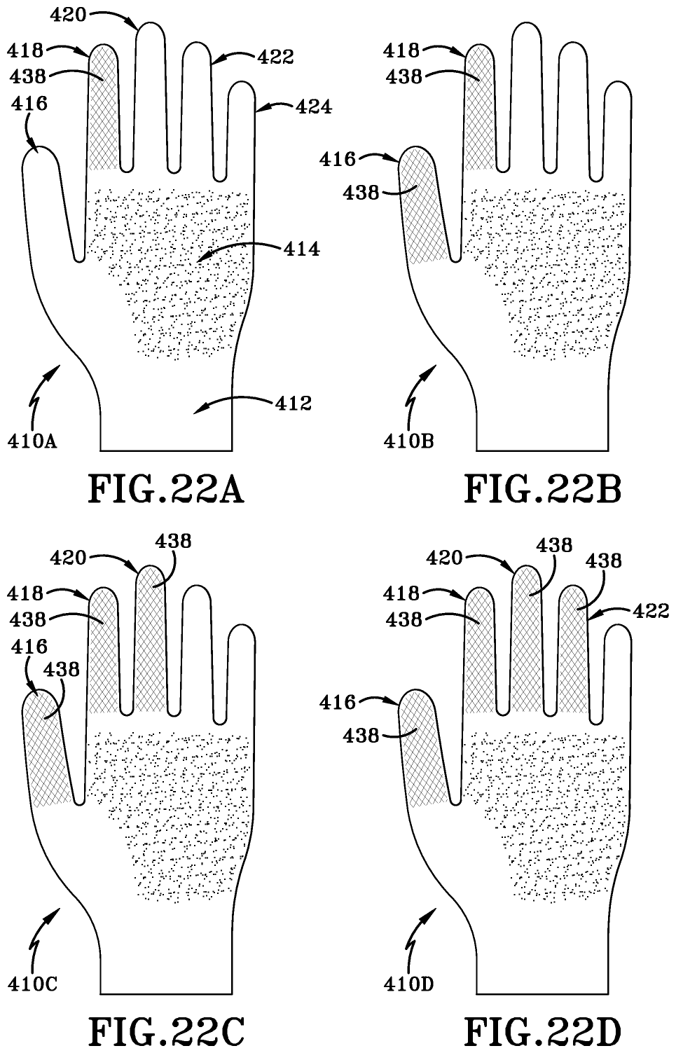

Referring now to FIGS. 22A to 22D, there are shown additional examples of the fifth embodiment glove 410 in accordance with the present disclosure.

FIG. 22A shows a second example of the fifth embodiment of the glove in accordance with the present disclosure, generally indicated as glove 410A. Glove 410A is identical to glove 410 in every aspect relating to structure and function except that instead of all digit of the digit regions being textured on their front surfaces, only index finger region 418 includes second texture 438. The front surfaces of all other digit regions 416, 420, 422, and 424 are smooth and free of texturing. Although not illustrated herein, it should be understood that the rear surface of index finger region also includes second texture 438a. It should be understood that while FIG. 22A shows that index finger region 418 is the only digit region with second textures 438 thereon, in other embodiments any other single digit region may be provided with second texture 438, 438a instead of index finger region 418. For example, only little finger region 424 may including second texture 438, 438a.

FIG. 22B shows a third example of the fifth embodiment of the glove in accordance with the present disclosure, generally indicated as glove 410B. Glove 410B is identical to glove 410 in every aspect relating to structure and function except that instead of the front and rear surfaces of all digit regions being textured with second texture 438, 438a, only index finger region 418 and thumb region 416 have front and rear surfaces with second texture 438, 438a thereon. The front and rear surfaces of all other digit regions on glove 410B are smooth and free of the texturing. It will be understood that while FIG. 22B shows thumb region 416 and index finger region 418 including second texture 438 on the front surfaces thereof and it is understood that the rear surfaces thereof include second texture 438a thereon, in other embodiments any other combination of two digit regions instead of thumb region 416 and index finger region 418 may have front and rear surfaces with second texture 438, 438a thereon. For example, thumb region 416 and ring finger region 420 may have front and rear surfaces with second texture 438, 438a thereon.

FIG. 22C shows a fourth example of the fifth embodiment of the glove in accordance with the present disclosure, generally indicated as glove 410C. Glove 410C is identical to glove 410 in every aspect relating to structure and function except that instead of the front and rear surfaces of all digit regions being textured, only thumb region 416, index finger region 418 and middle finger region 420 have front and rear surfaces with second texture 438, 438a thereon. The front and rear surfaces of the other digit regions are smooth and free of texture. It will be understood that while FIG. 22C shows thumb region 416, index finger region 418, and middle finger region 420 as the three digit regions with second texture 438 on the front surfaces thereof, in other embodiments the front surfaces of any other combination of three digit regions may be textured with second texture 438 instead of thumb region 416, index finger region 418, and middle finger region 420. Similarly, although not shown herein, the rear surfaces of the same combination of three other digit regions will be textured with second texture 438a thereon.

FIG. 22D shows a fifth example of the fifth embodiment of the glove in accordance with the present disclosure, generally indicated as glove 410D. Glove 410D is identical to glove 410 in every aspect relating to structure and function except that instead of the front and rear surfaces of all digit regions being textured with second texture 438, 438a, only thumb region 416, index finger region 418, middle finger region 420, and ring finger region 422 have front and rear surfaces with second texture 438, 438a thereon. The front and rear surfaces of little finger region 424 are smooth and free of texture. It will be understood that while thumb region 416, index finger region 418, middle finger region 420, and ring finger region 422 are the four digit regions with textured front and rear surfaces, in other embodiments the front and rear surfaces of any other combination of four digit regions may be textured with second texture 438, 438a instead of thumb region 416, index finger region 418, middle finger region 420, and ring finger region 422.

It will be understood that the decision as to which of the digit regions 416, 418, 420, 422, 424 will be textured on any of gloves 410A, 410B, 410C, and 410D may be based on the end use of the particular example of the fifth embodiment of the glove.

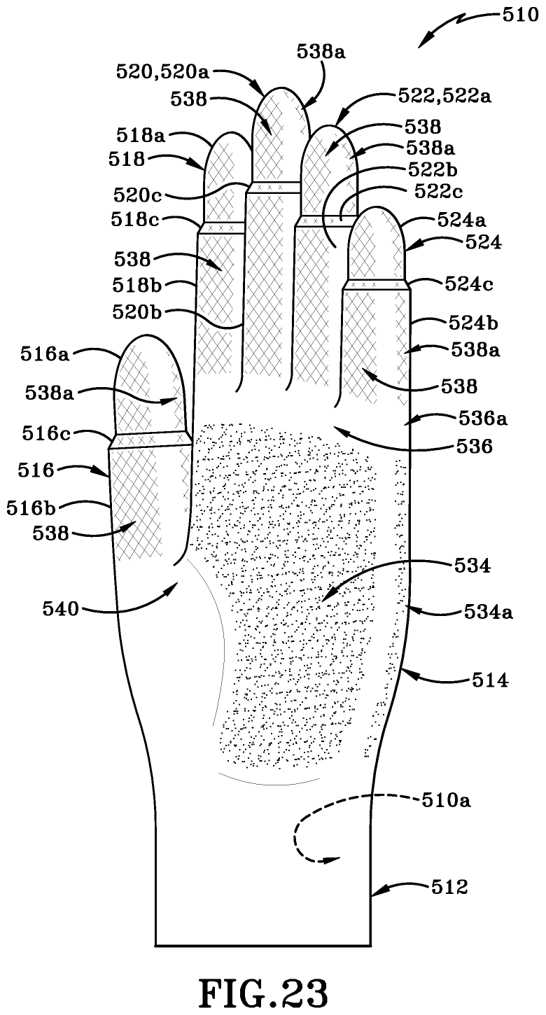

Referring now to FIGS. 23-25 there is shown a first example of a sixth embodiment of a glove in accordance with an aspect of the present disclosure, generally indicated at 510. Glove 510 comprises a wrist region 512, a palm region 514, a thumb region 516, an index finger region 518, a middle finger region 520, a ring finger region 522, and a little finger region 524. Glove 510 defines an interior cavity 510a which is configured to receive a hand of a person therein. Thumb region 516, index finger region 518, middle finger region 520, ring finger region 522, and little finger region 524 comprise digit regions which extend outwardly from palm region. The digit regions are configured to receive an associated one of a thumb, an index finger, a middle finger, a ring finger, and a little finger of the person's hand, respectively.

Glove 510, like glove 410, is substantially identical in structure and function to glove 410 except for the features which will be described later herein. Glove 510 is an ambidextrous glove. As such glove 510 is configured to be able to be worn on either of the left hand or the right hand of a person. Because glove 510 is an ambidextrous glove, all of the digit regions 516, 518, 520, 522, and 524 will be aligned along a common plane.

Glove 510 is provided with a first texture 534 on a front surface of palm region 514. The first texture 534 is provided in a substantially identical pattern on glove 510 as is first texture 434 on glove 410. Similarly, glove 510 includes two regions free of texture, generally indicated at 536 and 540 which are provided in a substantially identical location on glove 510 as are texture-free regions 436 and 440 on glove 410. Glove 510 further includes a second texture 538 on the front surfaces of each of the thumb region 516, index finger region 518, middle finger region 520, ring finger region 522, and little finger region 524. The second texture 538 is provided on glove 510 in substantially identical locations to the second texture 138 on glove 110. The first texture 534 is substantially identical to first texture 434 and the second texture 538 is substantially identical to second texture 438.

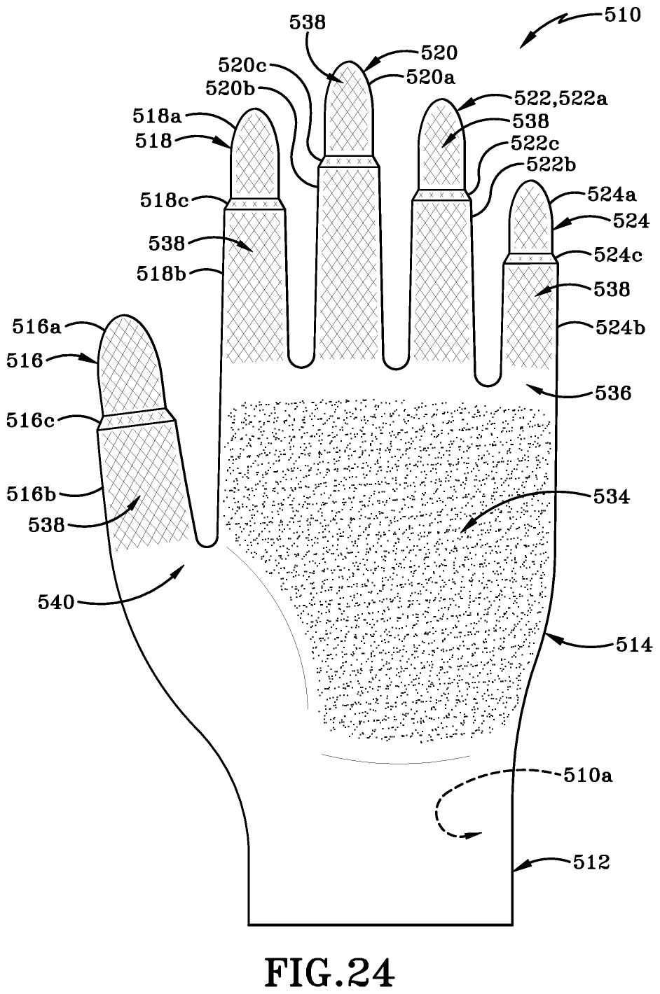

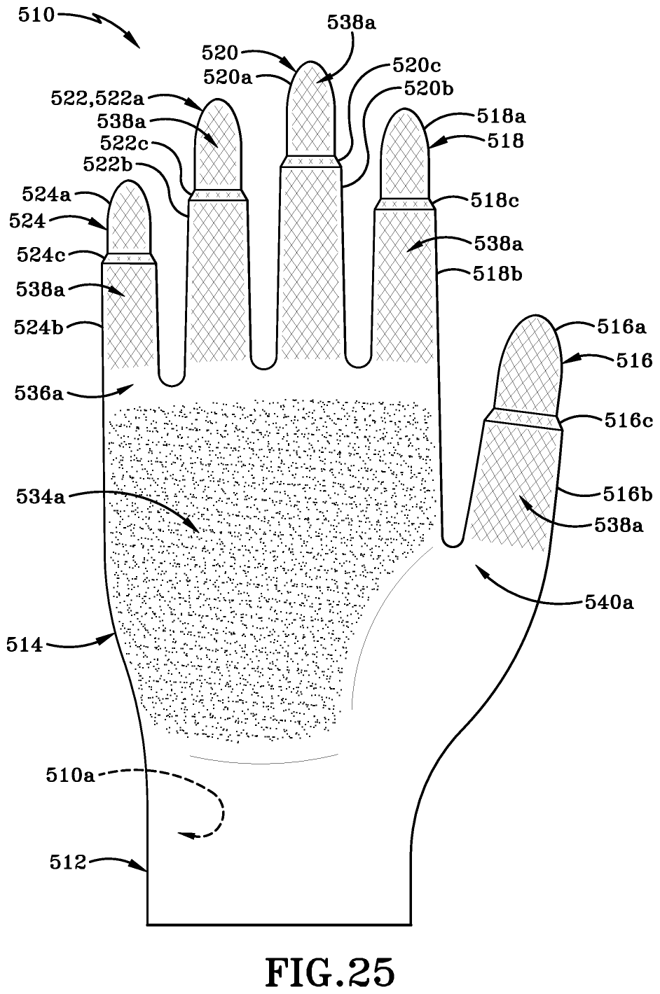

As indicated above, glove 510 is an ambidextrous glove and, therefore, a front surface of the glove 510, shown in FIG. 24, is identical to a rear surface of the glove, shown in FIG. 25. Glove 510 is provided with a first texture 534a on the rear surface of palm region 514 and the first texture 534a is provided in a substantially identical pattern on glove 510 as is first texture 534. Similarly, glove 510 includes two regions free of texture, generally indicated at 536a and 540a which are provided in a substantially identical location on the rear surface of glove 510 as are the texture-free regions 536 and 540 on the front surface of glove 510. Glove 510 further includes a second texture 538a on the rear surfaces of each of the thumb region 516, index finger region 518, middle finger region 520, ring finger region 522, and little finger region 524. The second texture 538a is provided on the rear surfaces of the digit regions of glove 510 in substantially identical locations to the second texture 538 provided on the front surfaces of the digit regions of glove 510. The rest of the glove 510 is substantially smooth and free of texture.

Glove 510 differs from glove 410 in that each of the digit regions 516, 518, 520, 522, 524 includes a fingertip region of a reduced circumference relative to a remaining portion of the associated digit region. In accordance with an aspect of the sixth embodiment glove 510, a transition region extends between the fingertip region and the remaining portion of each digit region. The transition region tapers in circumference from the remaining portion of the associated digit region to the reduced circumference of the fingertip region. As illustrated, the fingertip region provided on each digit region is of a bullet-tip shape. Referring to FIG. 24, Thumb region 516 includes a fingertip region 516a, a remaining portion 516b, and a transition region 516c. Index finger region 518 includes a fingertip region 518a, a remaining portion 518b, and a transition region 518c. Middle finger region 520 includes a fingertip region 520a, a remaining portion 520b, and a transition region 520c. Ring finger region 522 includes a fingertip region 522a, a remaining portion 522b, and a transition region 522c. Finally, little finger region 524 includes a fingertip region 524a, a remaining portion 524b, and a transition region 524c. The reduced circumference of the fingertip regions 516a, 518a, 520a, 522a, and 524a ensures that glove 510 closely conforms to the fingertips of the person's hand and thereby helps to ensure the person's tactile sensitivity and finger and thumb dexterity is maintained even while glove 510 is worn.

The provision of the reduced circumference fingertip regions and transitions regions on the digit regions of glove 510 is in contrast to the substantially constant circumference digit regions of glove 410. The glove 410 has digit regions which very gradually taper in circumference.

In accordance with an aspect of glove 510, second texture 538 is provided on the front and rear surfaces of each of the digit regions including the fingertip regions, remaining portions, and transition regions thereof. It will be understood that in other embodiments, second texture 238 may be omitted from one or more of the fingertip regions, the transitions regions, and remaining portions of the glove 510.

Glove 510 is used in a substantially identical manner to glove 410.

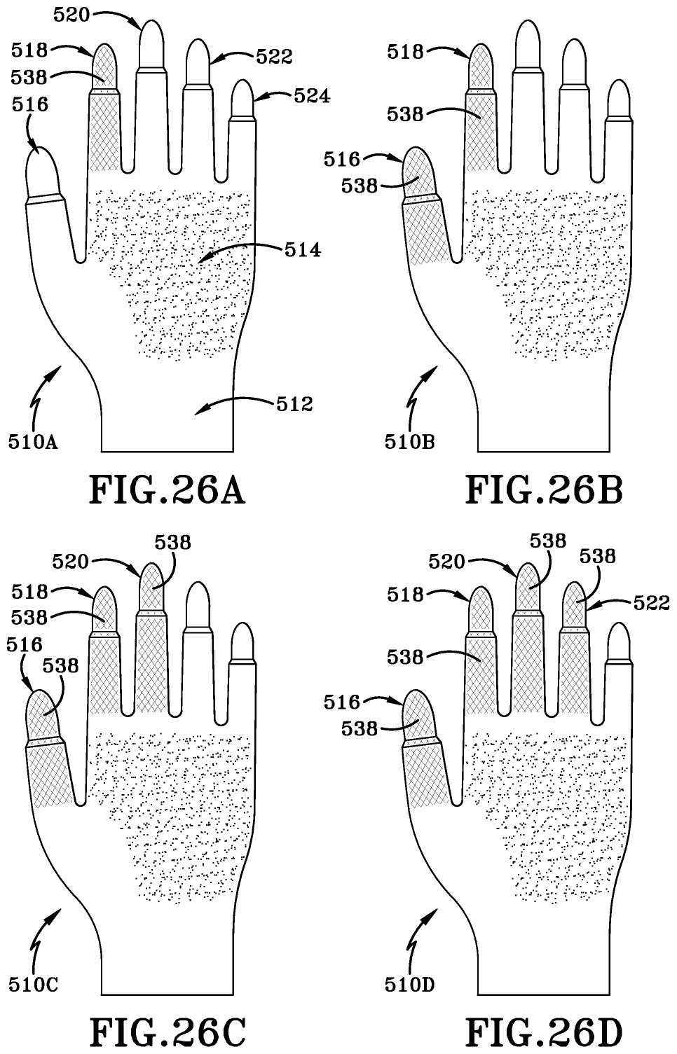

Referring now to FIGS. 26A to 26D, there are shown additional examples of the sixth embodiment glove 510 in accordance with the present disclosure.

FIG. 26A shows a second example of the sixth embodiment of the glove in accordance with the present disclosure, generally indicated as glove 510A. Glove 510A is identical to glove 510 in every aspect relating to structure and function except that instead of all digit of the digit regions being textured on their front surfaces, only index finger region 518 includes second texture 538. The front surfaces of all other digit regions 516, 520, 522, and 524 are smooth and free of texturing. Although not illustrated herein, it should be understood that the rear surface of index finger region also includes second texture 538a. It should be understood that while FIG. 26A shows that index finger region 518 is the only digit region with second textures 538 thereon, in other embodiments any other single digit region may be provided with second texture 538, 538a instead of index finger region 518. For example, only little finger region 524 may including second texture 538, 538a.

FIG. 26B shows a third example of the sixth embodiment of the glove in accordance with the present disclosure, generally indicated as glove 510B. Glove 510B is identical to glove 510 in every aspect relating to structure and function except that instead of the front and rear surfaces of all digit regions being textured with second texture 538, 538a, only index finger region 518 and thumb region 516 have front and rear surfaces with second texture 538, 538a thereon. The front and rear surfaces of all other digit regions on glove 510B are smooth and free of the texturing. It will be understood that while FIG. 26B shows thumb region 516 and index finger region 518 including second texture 538 on the front surfaces thereof and it is understood that the rear surfaces thereof also include second texture 538a thereon, in other embodiments any other combination of two digit regions instead of thumb region 516 and index finger region 518 may have front and rear surfaces with second texture 538, 538a thereon. For example, thumb region 516 and ring finger region 520 may have front and rear surfaces with second texture 538, 538a thereon.

FIG. 26C shows a fourth example of the sixth embodiment of the glove in accordance with the present disclosure, generally indicated as glove 510C. Glove 510C is identical to glove 510 in every aspect relating to structure and function except that instead of the front and rear surfaces of all digit regions being textured, only thumb region 516, index finger region 518 and middle finger region 520 have front and rear surfaces with second texture 538, 538a thereon. The front and rear surfaces of the other digit regions are smooth and free of texture. It will be understood that while FIG. 26C shows thumb region 516, index finger region 518, and middle finger region 520 as the three digit regions with second texture 538 on the front surfaces thereof, in other embodiments the front surfaces of any other combination of three digit regions may be textured with second texture 538 instead of thumb region 516, index finger region 518, and middle finger region 520. Similarly, although not shown herein, the rear surfaces of the same combination of three other digit regions will be textured with second texture 538a thereon.

FIG. 26D shows a fifth example of the sixth embodiment of the glove in accordance with the present disclosure, generally indicated as glove 510D. Glove 510D is identical to glove 510 in every aspect relating to structure and function except that instead of the front and rear surfaces of all digit regions being textured with second texture 538, 538a, only thumb region 516, index finger region 518, middle finger region 520, and ring finger region 522 have front and rear surfaces with second texture 538, 538a thereon. The front and rear surfaces of little finger region 524 are smooth and free of texture. It will be understood that while thumb region 516, index finger region 518, middle finger region 520, and ring finger region 522 are the four digit regions with textured front and rear surfaces, in other embodiments the front and rear surfaces of any other combination of four digit regions may be textured with second texture 538, 538a instead of thumb region 516, index finger region 518, middle finger region 520, and ring finger region 522.

It will be understood that the decision as to which of the digit regions 516, 518, 520, 522, 524 will be textured on any of gloves 510A, 510B, 510C, and 510D may be based on the end use of the particular example of the sixth embodiment of the glove.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A glove comprising:
a wrist region;
a palm region extending outwardly from the wrist region;
a plurality of digit regions extending outwardly from the palm region;
a first texture provided on the palm region; and
a second texture provided on one or more digit regions of the plurality of digit regions, wherein the second texture is different to the first texture.

2. The glove according to claim 1, wherein the first texture is a sand pattern.

3. The glove according to claim 1, wherein the first texture is micro-etched into a front surface of the palm region.

4. The glove according to claim 1, wherein the second texture is a diamond pattern produced on a front surface of the one or more digit regions.

5. The glove according to claim 1, further comprising a texture-free zone located between the first texture provided on the palm region and the second texture provided on the one or more digit regions.

6. The glove according to claim 1, wherein the first texture is provided on a front surface of the palm region and the second texture is provided on a front surface of the one or more digit regions, and wherein a rest of the glove is smooth and free of texture.

7. The glove according to claim 1, wherein the first texture is provided on a front surface of the palm region and extends between an upper boundary on the palm region to a lower boundary on the palm region, wherein the upper boundary is spaced a distance downwardly away from an imaginary line passing through a plurality of digit crotches extending between adjacent digit regions.

8. The glove according to claim 7, wherein the upper boundary is oriented generally orthogonally to a longitudinal axis of the wrist region and extends from proximate a first side of the front surface of the palm region to proximate a second side of the front surface of the palm region.

9. The glove according to claim 7, further comprising a zone extending between the imaginary line and the upper boundary, and wherein the zone is free of texture and is smooth.

10. The glove according to claim 7, wherein the lower boundary is located generally where the palm region of the glove transitions to the wrist region of the glove.

11. The glove according to claim 10, wherein the plurality of digit regions includes a thumb region, and wherein the lower boundary originates at a base of the thumb region where the thumb region transitions into the wrist region, and wherein the lower boundary is oriented transverse to a longitudinal axis of the wrist region.

12. The glove according to claim 7, wherein the front surface of the palm region has a first side and a second side, wherein the upper boundary extends between the first side and the second side, and wherein the lower boundary originates proximate the second side and terminates before reaching the first side.

13. The glove according to claim 12, further comprising an arcuate boundary extending between an end portion of the lower boundary and the first side, and wherein first texture is provided on the palm region between the upper boundary, the lower boundary, the first side, and the arcuate boundary.

14. The glove according to claim 13, wherein the front surface of the palm region which includes the first texture tapers in width between the first side of the palm region and the arcuate boundary to a minimum width along the lower boundary.

15. The glove according to claim 1, wherein the plurality of digit regions comprises a thumb region, an index finger region, a middle finger region, a ring finger region, and a little finger region; and wherein a digit crotch extends between adjacent digit regions of the plurality of digit regions, and wherein the second texture provided on a front surface of a respective digit region extends from a tip of the respective digit region to proximate the digit crotch.

16. The glove according to claim 1, further comprising a plurality of gripping zones provided in a rear surface of at least one of the plurality of digit regions.

17. A method of forming a glove comprising:
providing a former in a shape of a human hand;
dipping the former into liquid nitrile;
molding the glove on the former;
creating a first texture on a front surface of a palm region of the glove; and
creating a second texture on a front surface of one or more of a plurality of digit regions extending outwardly from the palm region, wherein the second texture is different to the first texture.

18. The method according to claim 17, wherein creating the first texture comprises micro-etching the first texture into the front surface of the palm region.

19. The method according to claim 17, wherein creating the second texture comprises molding a raised diamond pattern or embossing a raised diamond pattern into the front surface of the one or more of the plurality of digit regions.

20. The method according to claim 17, further comprising molding a plurality of gripping zones into a rear surface of at least one of the plurality of digit regions, where the rear surface is opposed to the front surface of the at least one of the plurality of digit regions.
